(19) United States
(12) Patent Application Publication
(10) Pub. No.: US 2023/0075799 A1
(43) Pub. Date: Mar. 9, 2023

(54) Using Typed Data for Causal Fault Discovery in Networks

(71) Applicant: ServiceNow, Inc., Santa Clara, CA (US)

(72) Inventors: Alexandre Drouin, Montreal (CA); Alexandre Lacoste, Montreal (CA); Perouz Taslakian, Montreal (CA); Philippe Brouillard, Montreal (CA); Sebastien Lachapelle, Montreal (CA)

(21) Appl. No.: 17/466,376

(22) Filed: Sep. 3, 2021

(51) Int. Cl. G06F 11/07; G06F 16/901

(52) U.S. Cl. CPC G06F 11/079; G06F 11/0709; G06F 11/0751; G06F 11/0775; G06F 16/9024

(57) ABSTRACT

Persistent storage may contain typed data of a plurality of types, directional relationships between pairs of the plurality of types, and a conditional dependency structure for the typed data. One or more processors may be configured to: generate an essential graph from the conditional dependency structure; orient the edges of the essential graph such that they are directed in accordance with the directional relationships; generate typed directed acyclic graphs (DAGs) that can be found in the essential graph; form a t-essential graph from a union of the typed DAGs; identify an event represented as a first vertex in the t-essential graph, wherein the first vertex is of a first type; trace backward from the first vertex and through the t-essential graph to identify a second vertex of a second type; and provide a representation of the second vertex as a cause of the event.

### BACKGROUND

Modern computing systems can be complex entities with numerous devices disposed within one or more networks, with each device operating a set of software applications. These software applications may interact with one another, across the network(s), in order to carry out higher-level services. For example, a web infrastructure may include load balancers, web server nodes, and database nodes, distributed in various arrangements, to provide web-based services.

These devices and software applications may be discovered and then represented in a configuration management database (CMDB) as configuration items with distinct sets of attributes. Pairwise or other types of relationships between configuration items may also be represented in the database. Such representations can be used to describe a service as a graph of configuration items (nodes) and relationships therebetween (edges). Once established, the graph can be used to visualize the service, as well as to debug problems experienced by users of the service and to determine the impact of changes made to any component of the service.

Nonetheless, given the volume and complexity of configuration item data for large networks, it is difficult to detect the faults in these networks as well as the root causes of these faults.

### SUMMARY

The embodiments herein overcome these and potentially other problems by generating causal graphs for devices and software applications. In particular, these graphs may be inferred from data that potentially goes beyond what is stored in a CMDB. Information from other databases and/or data sources may also be used, such as event logs (containing representations of events that have occurred on various devices and software applications), incident records (containing representations of problems reported by users), and knowledgebase documents (information that is related to the operation of a managed network and/or other topics).

Based on dependencies in this data, causal graphs can be constructed. The causal graphs may be typed directed acyclic graphs (DAGs) that constrain possible causal relationships between nodes therein based on the nature of variables (e.g., attributes, fields) associated with these nodes.

The addition of types overcomes limitations with existing causal analysis techniques that can only identify prohibitively large equivalence classes of possible causal graphs. It is demonstrated, both theoretically and empirically, that these embodiments can result in significant gains determination of tractable causal graphs that in turn produce more focused estimates of the root causes of various types of device, network, and/or system faults. With these embodiments, less time and computation is used for root cause analysis while more accurate results are provided.

Accordingly, a first example embodiment may involve persistent storage containing: (i) typed data relating to operation of a plurality of computing devices, wherein units of the typed data are of a plurality of types, (ii) directional relationships between pairs of the plurality of types, and (iii) a conditional dependency structure for the typed data. One or more processors may be configured to: generate an essential graph from the conditional dependency structure, wherein vertices of the essential graph represent the units of the typed data, and wherein edges of the essential graph respectively represent conditional dependencies between the vertices of the essential graph; orient the edges of the essential graph such that they are directed in accordance with the directional relationships; generate typed DAGs that can be found in the essential graph, wherein vertices of the typed DAGs are of the plurality of types, and wherein edges of the typed DAGs are in accordance with the directional relationships; form a t-essential graph from a union of the typed DAGs; identify an event related to a first computing device of the plurality of computing devices, wherein the event or the first computing device is represented as a first vertex in the t-essential graph, and wherein the first vertex is of a first type; trace backward from the first vertex and through the t-essential graph to identify a second vertex that is an ancestor of the first vertex, wherein the second vertex is of a second type, and wherein one of the directional relationships is from the second type to the first type; and provide a representation of the second vertex as a possible root cause of the event.

A second example embodiment may involve generating an essential graph from a conditional dependency structure for typed data relating to operation of a plurality of computing devices, wherein vertices of the essential graph represent units of the typed data, wherein the units of the typed data are of a plurality of types, and wherein edges of the essential graph respectively represent conditional dependencies between the vertices of the essential graph, wherein persistent storage contains (i) the typed data, (ii) directional relationships between pairs of the plurality of types, and (iii) the conditional dependency structure. The second example embodiment may further involve orienting the edges of the essential graph such that they are directed in accordance with the directional relationships. The second example embodiment may further involve generating typed DAGs that can be found in the essential graph, wherein vertices of the typed DAGs are of the plurality of types, and wherein edges of the typed DAGs are in accordance with the directional relationships. The second example embodiment may further involve forming a t-essential graph from a union of the typed DAGs. The second example embodiment may further involve identifying an event related to a first computing device of the plurality of computing devices, wherein the event or the first computing device is represented as a first vertex in the t-essential graph, and wherein the first vertex is of a first type. The second example embodiment may further involve tracing backward from the first vertex and through the t-essential graph to identify a second vertex that is an ancestor of the first vertex, wherein the second vertex is of a second type, and wherein one of the directional relationships is from the second type to the first type. The second example embodiment may further involve providing a representation of the second vertex as a possible root cause of the event.

In a third example embodiment, an article of manufacture may include a non-transitory computer-readable medium, having stored thereon program instructions that, upon execution by a computing system, cause the computing system to perform operations in accordance with the first and/or second example embodiment.

In a fourth example embodiment, a computing system may include at least one processor, as well as memory and program instructions. The program instructions may be stored in the memory, and upon execution by the at least one processor, cause the computing system to perform operations in accordance with the first and/or second example embodiment.

In a fifth example embodiment, a system may include various means for carrying out each of the operations of the first and/or second example embodiment.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1 illustrates a schematic drawing of a computing device, in accordance with example embodiments.

FIG. 2 illustrates a schematic drawing of a server device cluster, in accordance with example embodiments.

FIG. 3 depicts a remote network management architecture, in accordance with example embodiments.

FIG. 4 depicts a communication environment involving a remote network management architecture, in accordance with example embodiments.

FIG. 5A depicts another communication environment involving a remote network management architecture, in accordance with example embodiments.

FIG. 5B is a flow chart, in accordance with example embodiments.

FIG. 6A is a graph representing components of a network service, in accordance with example embodiments.

FIG. 6B depicts types of databases and/or data sources that can be used to generate typed causal graphs, in accordance with example embodiments.

FIG. 7 depicts types of directed acyclic graph structures, in accordance with example embodiments.

FIG. 8 depicts edge orientations of three graphs, in accordance with example embodiments.

FIG. 9A depicts a set of rules for removing edges from a graph, in accordance with example embodiments.

FIG. 9B depicts a further rule for removing edges from a graph, in accordance with example embodiments.

FIGS. 10A, 10B, and 10C depict the advantages of t-essential graphs in terms of equivalence class size, in accordance with example embodiments.

FIG. 11 is a flow chart, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless stated as such. Thus, other embodiments can be utilized and other changes can be made without departing from the scope of the subject matter presented herein.

Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations. For example, the separation of features into “client” and “server” components may occur in a number of ways.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

### I. Introduction

A large enterprise is a complex entity with many interrelated operations. Some of these are found across the enterprise, such as human resources (HR), supply chain, information technology (IT), and finance. However, each enterprise also has its own unique operations that provide essential capabilities and/or create competitive advantages.

To support widely-implemented operations, enterprises typically use off-the-shelf software applications, such as customer relationship management (CRM) and human capital management (HCM) packages. However, they may also need custom software applications to meet their own unique requirements. A large enterprise often has dozens or hundreds of these custom software applications. Nonetheless, the advantages provided by the embodiments herein are not limited to large enterprises and may be applicable to an enterprise, or any other type of organization, of any size.

Many such software applications are developed by individual departments within the enterprise. These range from simple spreadsheets to custom-built software tools and databases. But the proliferation of siloed custom software applications has numerous disadvantages. It negatively impacts an enterprise's ability to run and grow its operations, innovate, and meet regulatory requirements. The enterprise may find it difficult to integrate, streamline, and enhance its operations due to lack of a single system that unifies its subsystems and data.

To efficiently create custom applications, enterprises would benefit from a remotely-hosted application platform that eliminates unnecessary development complexity. The goal of such a platform would be to reduce time-consuming, repetitive application development tasks so that software engineers and individuals in other roles can focus on developing unique, high-value features.

In order to achieve this goal, the concept of Application Platform as a Service (aPaaS) is introduced, to intelligently automate workflows throughout the enterprise. An aPaaS system is hosted remotely from the enterprise, but may access data, applications, and services within the enterprise by way of secure connections. Such an aPaaS system may have a number of advantageous capabilities and characteristics. These advantages and characteristics may be able to improve the enterprise's operations and workflows for IT, HR, CRM, customer service, application development, and security.

The aPaaS system may support development and execution of model-view-controller (MVC) applications. MVC applications divide their functionality into three interconnected parts (model, view, and controller) in order to isolate representations of information from the manner in which the information is presented to the user, thereby allowing for efficient code reuse and parallel development. These applications may be web-based, and offer create, read, update, and delete (CRUD) capabilities. This allows new applications to be built on a common application infrastructure.

The aPaaS system may support standardized application components, such as a standardized set of widgets for graphical user interface (GUI) development. In this way, applications built using the aPaaS system have a common look and feel. Other software components and modules may be standardized as well. In some cases, this look and feel can be branded or skinned with an enterprise's custom logos and/or color schemes.

The aPaaS system may support the ability to configure the behavior of applications using metadata. This allows application behaviors to be rapidly adapted to meet specific needs. Such an approach reduces development time and increases flexibility. Further, the aPaaS system may support GUI tools that facilitate metadata creation and management, thus reducing errors in the metadata.

The aPaaS system may support clearly-defined interfaces between applications, so that software developers can avoid unwanted inter-application dependencies. Thus, the aPaaS system may implement a service layer in which persistent state information and other data are stored.

The aPaaS system may support a rich set of integration features so that the applications thereon can interact with legacy applications and third-party applications. For instance, the aPaaS system may support a custom employee-onboarding system that integrates with legacy HR, IT, and accounting systems.

The aPaaS system may support enterprise-grade security. Furthermore, since the aPaaS system may be remotely hosted, it should also utilize security procedures when it interacts with systems in the enterprise or third-party networks and services hosted outside of the enterprise. For example, the aPaaS system may be configured to share data amongst the enterprise and other parties to detect and identify common security threats.

Other features, functionality, and advantages of an aPaaS system may exist. This description is for purpose of example and is not intended to be limiting.

As an example of the aPaaS development process, a software developer may be tasked to create a new application using the aPaaS system. First, the developer may define the data model, which specifies the types of data that the application uses and the relationships therebetween. Then, via a GUI of the aPaaS system, the developer enters (e.g., uploads) the data model. The aPaaS system automatically creates all of the corresponding database tables, fields, and relationships, which can then be accessed via an object-oriented services layer.

In addition, the aPaaS system can also build a fully-functional MVC application with client-side interfaces and server-side CRUD logic. This generated application may serve as the basis of further development for the user. Advantageously, the developer does not have to spend a large amount of time on basic application functionality. Further, since the application may be web-based, it can be accessed from any Internet-enabled client device. Alternatively or additionally, a local copy of the application may be able to be accessed, for instance, when Internet service is not available.

The aPaaS system may also support a rich set of pre-defined functionality that can be added to applications. These features include support for searching, email, templating, workflow design, reporting, analytics, social media, scripting, mobile-friendly output, and customized GUIs.

Such an aPaaS system may represent a GUI in various ways. For example, a server device of the aPaaS system may generate a representation of a GUI using a combination of HTML and JAVASCRIPT®. The JAVASCRIPT® may include client-side executable code, server-side executable code, or both. The server device may transmit or otherwise provide this representation to a client device for the client device to display on a screen according to its locally-defined look and feel. Alternatively, a representation of a GUI may take other forms, such as an intermediate form (e.g., JAVA® byte-code) that a client device can use to directly generate graphical output therefrom. Other possibilities exist.

Further, user interaction with GUI elements, such as buttons, menus, tabs, sliders, checkboxes, toggles, etc. may be referred to as “selection”, “activation”, or “actuation” thereof. These terms may be used regardless of whether the GUI elements are interacted with by way of keyboard, pointing device, touchscreen, or another mechanism.

An aPaaS architecture is particularly powerful when integrated with an enterprise's network and used to manage such a network. The following embodiments describe architectural and functional aspects of example aPaaS systems, as well as the features and advantages thereof.

### II. Example Computing Devices and Cloud-Based Computing Environments

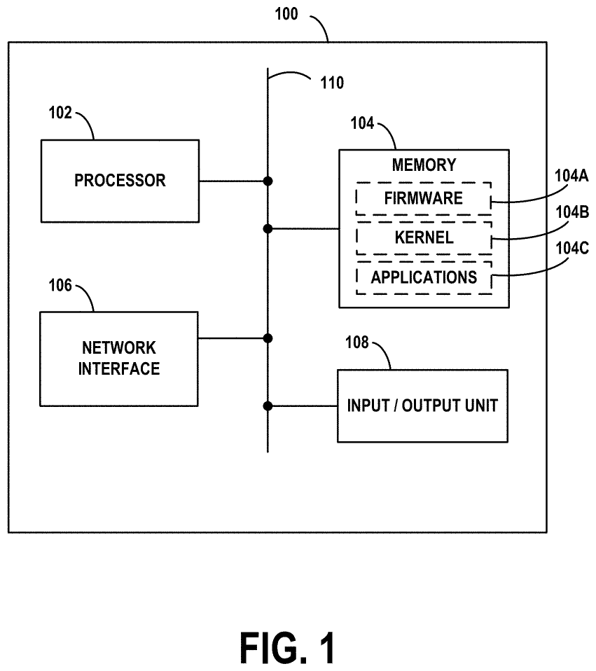

FIG. 1 is a simplified block diagram exemplifying a computing device 100, illustrating some of the components that could be included in a computing device arranged to operate in accordance with the embodiments herein. Computing device 100 could be a client device (e.g., a device actively operated by a user), a server device (e.g., a device that provides computational services to client devices), or some other type of computational platform. Some server devices may operate as client devices from time to time in order to perform particular operations, and some client devices may incorporate server features.

In this example, computing device 100 includes processor 102, memory 104, network interface 106, and input/output unit 108, all of which may be coupled by system bus 110 or a similar mechanism. In some embodiments, computing device 100 may include other components and/or peripheral devices (e.g., detachable storage, printers, and so on).

Processor 102 may be one or more of any type of computer processing element, such as a central processing unit (CPU), a co-processor (e.g., a mathematics, graphics, or encryption co-processor), a digital signal processor (DSP), a network processor, and/or a form of integrated circuit or controller that performs processor operations. In some cases, processor 102 may be one or more single-core processors. In other cases, processor 102 may be one or more multi-core processors with multiple independent processing units. Processor 102 may also include register memory for temporarily storing instructions being executed and related data, as well as cache memory for temporarily storing recently-used instructions and data.

Memory 104 may be any form of computer-usable memory, including but not limited to random access memory (RAM), read-only memory (ROM), and non-volatile memory (e.g., flash memory, hard disk drives, solid state drives, compact discs (CDs), digital video discs (DVDs), and/or tape storage). Thus, memory 104 represents both main memory units, as well as long-term storage. Other types of memory may include biological memory.

Memory 104 may store program instructions and/or data on which program instructions may operate. By way of example, memory 104 may store these program instructions on a non-transitory, computer-readable medium, such that the instructions are executable by processor 102 to carry out any of the methods, processes, or operations disclosed in this specification or the accompanying drawings.

As shown in FIG. 1, memory 104 may include firmware 104A, kernel 104B, and/or applications 104C. Firmware 104A may be program code used to boot or otherwise initiate some or all of computing device 100. Kernel 104B may be an operating system, including modules for memory management, scheduling and management of processes, input/output, and communication. Kernel 104B may also include device drivers that allow the operating system to communicate with the hardware modules (e.g., memory units, networking interfaces, ports, and buses) of computing device 100. Applications 104C may be one or more user-space software programs, such as web browsers or email clients, as well as any software libraries used by these programs. Memory 104 may also store data used by these and other programs and applications.

Network interface 106 may take the form of one or more wireline interfaces, such as Ethernet (e.g., Fast Ethernet, Gigabit Ethernet, and so on). Network interface 106 may also support communication over one or more non-Ethernet media, such as coaxial cables or power lines, or over wide-area media, such as Synchronous Optical Networking (SONET) or digital subscriber line (DSL) technologies. Network interface 106 may additionally take the form of one or more wireless interfaces, such as IEEE 802.11 (Wifi), BLUETOOTH®, global positioning system (GPS), or a wide-area wireless interface. However, other forms of physical layer interfaces and other types of standard or proprietary communication protocols may be used over network interface 106. Furthermore, network interface 106 may comprise multiple physical interfaces. For instance, some embodiments of computing device 100 may include Ethernet, BLUETOOTH®, and Wifi interfaces.

Input/output unit 108 may facilitate user and peripheral device interaction with computing device 100. Input/output unit 108 may include one or more types of input devices, such as a keyboard, a mouse, a touch screen, and so on. Similarly, input/output unit 108 may include one or more types of output devices, such as a screen, monitor, printer, and/or one or more light emitting diodes (LEDs). Additionally or alternatively, computing device 100 may communicate with other devices using a universal serial bus (USB) or high-definition multimedia interface (HDMI) port interface, for example.

In some embodiments, one or more computing devices like computing device 100 may be deployed to support an aPaaS architecture. The exact physical location, connectivity, and configuration of these computing devices may be unknown and/or unimportant to client devices. Accordingly, the computing devices may be referred to as “cloud-based” devices that may be housed at various remote data center locations.

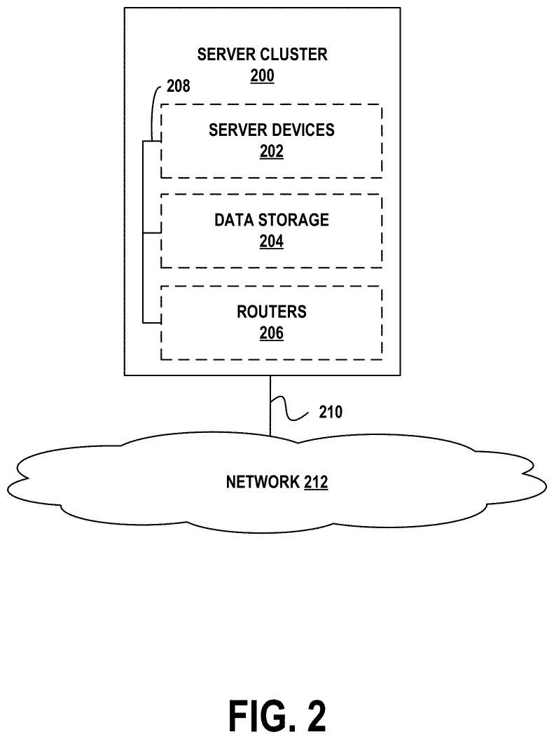

FIG. 2 depicts a cloud-based server cluster 200 in accordance with example embodiments. In FIG. 2, operations of a computing device (e.g., computing device 100) may be distributed between server devices 202, data storage 204, and routers 206, all of which may be connected by local cluster network 208. The number of server devices 202, data storages 204, and routers 206 in server cluster 200 may depend on the computing task(s) and/or applications assigned to server cluster 200.

For example, server devices 202 can be configured to perform various computing tasks of computing device 100. Thus, computing tasks can be distributed among one or more of server devices 202. To the extent that these computing tasks can be performed in parallel, such a distribution of tasks may reduce the total time to complete these tasks and return a result. For purposes of simplicity, both server cluster 200 and individual server devices 202 may be referred to as a “server device.” This nomenclature should be understood to imply that one or more distinct server devices, data storage devices, and cluster routers may be involved in server device operations.

Data storage 204 may be data storage arrays that include drive array controllers configured to manage read and write access to groups of hard disk drives and/or solid state drives. The drive array controllers, alone or in conjunction with server devices 202, may also be configured to manage backup or redundant copies of the data stored in data storage 204 to protect against drive failures or other types of failures that prevent one or more of server devices 202 from accessing units of data storage 204. Other types of memory aside from drives may be used.

Routers 206 may include networking equipment configured to provide internal and external communications for server cluster 200. For example, routers 206 may include one or more packet-switching and/or routing devices (including switches and/or gateways) configured to provide (i) network communications between server devices 202 and data storage 204 via local cluster network 208, and/or (ii) network communications between server cluster 200 and other devices via communication link 210 to network 212.

Additionally, the configuration of routers 206 can be based at least in part on the data communication requirements of server devices 202 and data storage 204, the latency and throughput of the local cluster network 208, the latency, throughput, and cost of communication link 210, and/or other factors that may contribute to the cost, speed, fault-tolerance, resiliency, efficiency, and/or other design goals of the system architecture.

As a possible example, data storage 204 may include any form of database, such as a structured query language (SQL) database. Various types of data structures may store the information in such a database, including but not limited to tables, arrays, lists, trees, and tuples. Furthermore, any databases in data storage 204 may be monolithic or distributed across multiple physical devices.

Server devices 202 may be configured to transmit data to and receive data from data storage 204. This transmission and retrieval may take the form of SQL queries or other types of database queries, and the output of such queries, respectively. Additional text, images, video, and/or audio may be included as well. Furthermore, server devices 202 may organize the received data into web page or web application representations. Such a representation may take the form of a markup language, such as the hypertext markup language (HTML), the extensible markup language (XML), or some other standardized or proprietary format. Moreover, server devices 202 may have the capability of executing various types of computerized scripting languages, such as but not limited to Perl, Python, PHP Hypertext Preprocessor (PHP), Active Server Pages (ASP), JAVASCRIPT®, and so on. Computer program code written in these languages may facilitate the providing of web pages to client devices, as well as client device interaction with the web pages. Alternatively or additionally, JAVA® may be used to facilitate generation of web pages and/or to provide web application functionality.

### III. Example Remote Network Management Architecture

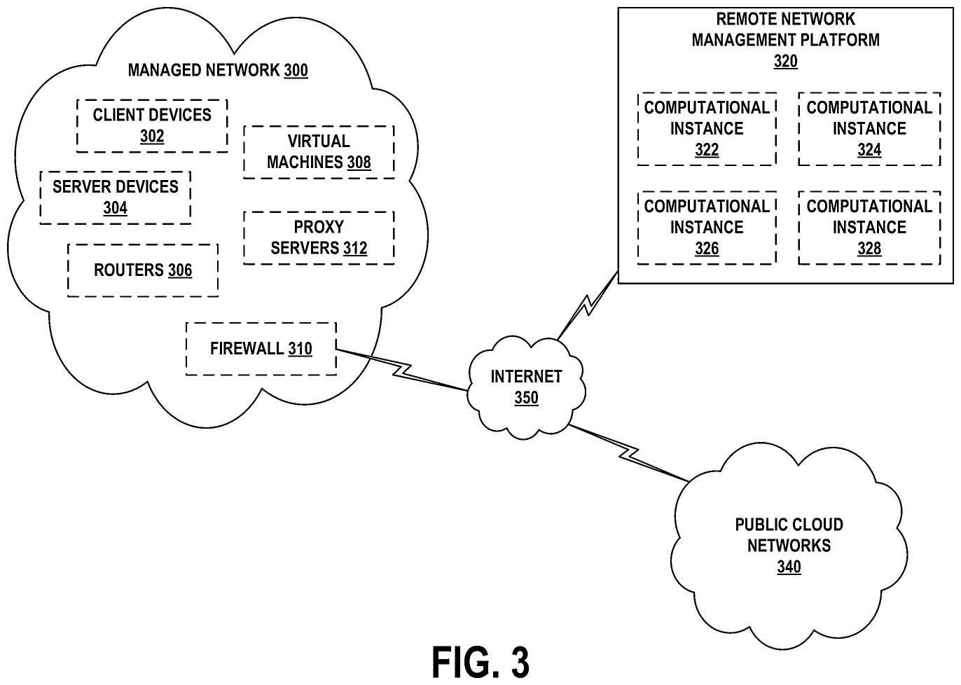

FIG. 3 depicts a remote network management architecture, in accordance with example embodiments. This architecture includes three main components—managed network 300, remote network management platform 320, and public cloud networks 340—all connected by way of Internet 350.

A. Managed Networks

Managed network 300 may be, for example, an enterprise network used by an entity for computing and communications tasks, as well as storage of data. Thus, managed network 300 may include client devices 302, server devices 304, routers 306, virtual machines 308, firewall 310, and/or proxy servers 312. Client devices 302 may be embodied by computing device 100, server devices 304 may be embodied by computing device 100 or server cluster 200, and routers 306 may be any type of router, switch, or gateway.

Virtual machines 308 may be embodied by one or more of computing device 100 or server cluster 200. In general, a virtual machine is an emulation of a computing system, and mimics the functionality (e.g., processor, memory, and communication resources) of a physical computer. One physical computing system, such as server cluster 200, may support up to thousands of individual virtual machines. In some embodiments, virtual machines 308 may be managed by a centralized server device or application that facilitates allocation of physical computing resources to individual virtual machines, as well as performance and error reporting. Enterprises often employ virtual machines in order to allocate computing resources in an efficient, as needed fashion. Providers of virtualized computing systems include VMWARE® and MICROSOFT®.

Firewall 310 may be one or more specialized routers or server devices that protect managed network 300 from unauthorized attempts to access the devices, applications, and services therein, while allowing authorized communication that is initiated from managed network 300. Firewall 310 may also provide intrusion detection, web filtering, virus scanning, application-layer gateways, and other applications or services. In some embodiments not shown in FIG. 3, managed network 300 may include one or more virtual private network (VPN) gateways with which it communicates with remote network management platform 320 (see below).

Managed network 300 may also include one or more proxy servers 312. An embodiment of proxy servers 312 may be a server application that facilitates communication and movement of data between managed network 300, remote network management platform 320, and public cloud networks 340. In particular, proxy servers 312 may be able to establish and maintain secure communication sessions with one or more computational instances of remote network management platform 320. By way of such a session, remote network management platform 320 may be able to discover and manage aspects of the architecture and configuration of managed network 300 and its components. Possibly with the assistance of proxy servers 312, remote network management platform 320 may also be able to discover and manage aspects of public cloud networks 340 that are used by managed network 300.

Firewalls, such as firewall 310, typically deny all communication sessions that are incoming by way of Internet 350, unless such a session was ultimately initiated from behind the firewall (i.e., from a device on managed network 300) or the firewall has been explicitly configured to support the session. By placing proxy servers 312 behind firewall 310 (e.g., within managed network 300 and protected by firewall 310), proxy servers 312 may be able to initiate these communication sessions through firewall 310. Thus, firewall 310 might not have to be specifically configured to support incoming sessions from remote network management platform 320, thereby avoiding potential security risks to managed network 300.

In some cases, managed network 300 may consist of a few devices and a small number of networks. In other deployments, managed network 300 may span multiple physical locations and include hundreds of networks and hundreds of thousands of devices. Thus, the architecture depicted in FIG. 3 is capable of scaling up or down by orders of magnitude.

Furthermore, depending on the size, architecture, and connectivity of managed network 300, a varying number of proxy servers 312 may be deployed therein. For example, each one of proxy servers 312 may be responsible for communicating with remote network management platform 320 regarding a portion of managed network 300. Alternatively or additionally, sets of two or more proxy servers may be assigned to such a portion of managed network 300 for purposes of load balancing, redundancy, and/or high availability.

B. Remote Network Management Platforms

Remote network management platform 320 is a hosted environment that provides aPaaS services to users, particularly to the operator of managed network 300. These services may take the form of web-based portals, for example, using the aforementioned web-based technologies. Thus, a user can securely access remote network management platform 320 from, for example, client devices 302, or potentially from a client device outside of managed network 300. By way of the web-based portals, users may design, test, and deploy applications, generate reports, view analytics, and perform other tasks. Remote network management platform 320 may also be referred to as a multi-application platform.

As shown in FIG. 3, remote network management platform 320 includes four computational instances 322, 324, 326, and 328. Each of these computational instances may represent one or more server nodes operating dedicated copies of the aPaaS software and/or one or more database nodes. The arrangement of server and database nodes on physical server devices and/or virtual machines can be flexible and may vary based on enterprise needs. In combination, these nodes may provide a set of web portals, services, and applications (e.g., a wholly-functioning aPaaS system) available to a particular enterprise. In some cases, a single enterprise may use multiple computational instances.

For example, managed network 300 may be an enterprise customer of remote network management platform 320, and may use computational instances 322, 324, and 326. The reason for providing multiple computational instances to one customer is that the customer may wish to independently develop, test, and deploy its applications and services. Thus, computational instance 322 may be dedicated to application development related to managed network 300, computational instance 324 may be dedicated to testing these applications, and computational instance 326 may be dedicated to the live operation of tested applications and services. A computational instance may also be referred to as a hosted instance, a remote instance, a customer instance, or by some other designation. Any application deployed onto a computational instance may be a scoped application, in that its access to databases within the computational instance can be restricted to certain elements therein (e.g., one or more particular database tables or particular rows within one or more database tables).

For purposes of clarity, the disclosure herein refers to the arrangement of application nodes, database nodes, aPaaS software executing thereon, and underlying hardware as a “computational instance.” Note that users may colloquially refer to the graphical user interfaces provided thereby as “instances.” But unless it is defined otherwise herein, a “computational instance” is a computing system disposed within remote network management platform 320.

The multi-instance architecture of remote network management platform 320 is in contrast to conventional multi-tenant architectures, over which multi-instance architectures exhibit several advantages. In multi-tenant architectures, data from different customers (e.g., enterprises) are comingled in a single database. While these customers' data are separate from one another, the separation is enforced by the software that operates the single database. As a consequence, a security breach in this system may affect all customers' data, creating additional risk, especially for entities subject to governmental, healthcare, and/or financial regulation. Furthermore, any database operations that affect one customer will likely affect all customers sharing that database. Thus, if there is an outage due to hardware or software errors, this outage affects all such customers. Likewise, if the database is to be upgraded to meet the needs of one customer, it will be unavailable to all customers during the upgrade process. Often, such maintenance windows will be long, due to the size of the shared database.

In contrast, the multi-instance architecture provides each customer with its own database in a dedicated computing instance. This prevents comingling of customer data, and allows each instance to be independently managed. For example, when one customer's instance experiences an outage due to errors or an upgrade, other computational instances are not impacted. Maintenance down time is limited because the database only contains one customer's data. Further, the simpler design of the multi-instance architecture allows redundant copies of each customer database and instance to be deployed in a geographically diverse fashion. This facilitates high availability, where the live version of the customer's instance can be moved when faults are detected or maintenance is being performed.

In some embodiments, remote network management platform 320 may include one or more central instances, controlled by the entity that operates this platform. Like a computational instance, a central instance may include some number of application and database nodes disposed upon some number of physical server devices or virtual machines. Such a central instance may serve as a repository for specific configurations of computational instances as well as data that can be shared amongst at least some of the computational instances. For instance, definitions of common security threats that could occur on the computational instances, software packages that are commonly discovered on the computational instances, and/or an application store for applications that can be deployed to the computational instances may reside in a central instance. Computational instances may communicate with central instances by way of well-defined interfaces in order to obtain this data.

In order to support multiple computational instances in an efficient fashion, remote network management platform 320 may implement a plurality of these instances on a single hardware platform. For example, when the aPaaS system is implemented on a server cluster such as server cluster 200, it may operate virtual machines that dedicate varying amounts of computational, storage, and communication resources to instances. But full virtualization of server cluster 200 might not be necessary, and other mechanisms may be used to separate instances. In some examples, each instance may have a dedicated account and one or more dedicated databases on server cluster 200. Alternatively, a computational instance such as computational instance 322 may span multiple physical devices.

In some cases, a single server cluster of remote network management platform 320 may support multiple independent enterprises. Furthermore, as described below, remote network management platform 320 may include multiple server clusters deployed in geographically diverse data centers in order to facilitate load balancing, redundancy, and/or high availability.

C. Public Cloud Networks

Public cloud networks 340 may be remote server devices (e.g., a plurality of server clusters such as server cluster 200) that can be used for outsourced computation, data storage, communication, and service hosting operations. These servers may be virtualized (i.e., the servers may be virtual machines). Examples of public cloud networks 340 may include AMAZON WEB SERVICES® and MICROSOFT® AZURE®. Like remote network management platform 320, multiple server clusters supporting public cloud networks 340 may be deployed at geographically diverse locations for purposes of load balancing, redundancy, and/or high availability.

Managed network 300 may use one or more of public cloud networks 340 to deploy applications and services to its clients and customers. For instance, if managed network 300 provides online music streaming services, public cloud networks 340 may store the music files and provide web interface and streaming capabilities. In this way, the enterprise of managed network 300 does not have to build and maintain its own servers for these operations.

Remote network management platform 320 may include modules that integrate with public cloud networks 340 to expose virtual machines and managed services therein to managed network 300. The modules may allow users to request virtual resources, discover allocated resources, and provide flexible reporting for public cloud networks 340. In order to establish this functionality, a user from managed network 300 might first establish an account with public cloud networks 340, and request a set of associated resources. Then, the user may enter the account information into the appropriate modules of remote network management platform 320. These modules may then automatically discover the manageable resources in the account, and also provide reports related to usage, performance, and billing.

D. Communication Support and Other Operations

Internet 350 may represent a portion of the global Internet. However, Internet 350 may alternatively represent a different type of network, such as a private wide-area or local-area packet-switched network.

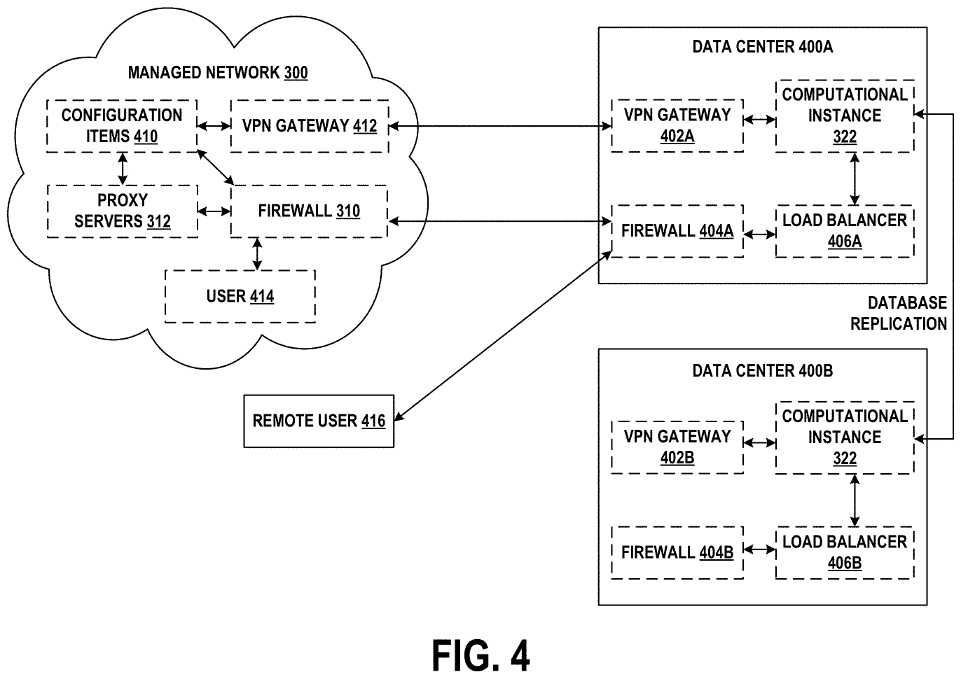

FIG. 4 further illustrates the communication environment between managed network 300 and computational instance 322, and introduces additional features and alternative embodiments. In FIG. 4, computational instance 322 is replicated, in whole or in part, across data centers 400A and 400B. These data centers may be geographically distant from one another, perhaps in different cities or different countries. Each data center includes support equipment that facilitates communication with managed network 300, as well as remote users.

In data center 400A, network traffic to and from external devices flows either through VPN gateway 402A or firewall 404A. VPN gateway 402A may be peered with VPN gateway 412 of managed network 300 by way of a security protocol such as Internet Protocol Security (IPSEC) or Transport Layer Security (TLS). Firewall 404A may be configured to allow access from authorized users, such as user 414 and remote user 416, and to deny access to unauthorized users. By way of firewall 404A, these users may access computational instance 322, and possibly other computational instances. Load balancer 406A may be used to distribute traffic amongst one or more physical or virtual server devices that host computational instance 322. Load balancer 406A may simplify user access by hiding the internal configuration of data center 400A, (e.g., computational instance 322) from client devices. For instance, if computational instance 322 includes multiple physical or virtual computing devices that share access to multiple databases, load balancer 406A may distribute network traffic and processing tasks across these computing devices and databases so that no one computing device or database is significantly busier than the others. In some embodiments, computational instance 322 may include VPN gateway 402A, firewall 404A, and load balancer 406A.

Data center 400B may include its own versions of the components in data center 400A. Thus, VPN gateway 402B, firewall 404B, and load balancer 406B may perform the same or similar operations as VPN gateway 402A, firewall 404A, and load balancer 406A, respectively. Further, by way of real-time or near-real-time database replication and/or other operations, computational instance 322 may exist simultaneously in data centers 400A and 400B.

Data centers 400A and 400B as shown in FIG. 4 may facilitate redundancy and high availability. In the configuration of FIG. 4, data center 400A is active and data center 400B is passive. Thus, data center 400A is serving all traffic to and from managed network 300, while the version of computational instance 322 in data center 400B is being updated in near-real-time. Other configurations, such as one in which both data centers are active, may be supported.

Should data center 400A fail in some fashion or otherwise become unavailable to users, data center 400B can take over as the active data center. For example, domain name system (DNS) servers that associate a domain name of computational instance 322 with one or more Internet Protocol (IP) addresses of data center 400A may re-associate the domain name with one or more IP addresses of data center 400B. After this re-association completes (which may take less than one second or several seconds), users may access computational instance 322 by way of data center 400B.

FIG. 4 also illustrates a possible configuration of managed network 300. As noted above, proxy servers 312 and user 414 may access computational instance 322 through firewall 310. Proxy servers 312 may also access configuration items 410. In FIG. 4, configuration items 410 may refer to any or all of client devices 302, server devices 304, routers 306, and virtual machines 308, any applications or services executing thereon, as well as relationships between devices, applications, and services. Thus, the term “configuration items” may be shorthand for any physical or virtual device, or any application or service remotely discoverable or managed by computational instance 322, or relationships between discovered devices, applications, and services. Configuration items may be represented in a configuration management database (CMDB) of computational instance 322.

As noted above, VPN gateway 412 may provide a dedicated VPN to VPN gateway 402A. Such a VPN may be helpful when there is a significant amount of traffic between managed network 300 and computational instance 322, or security policies otherwise suggest or require use of a VPN between these sites. In some embodiments, any device in managed network 300 and/or computational instance 322 that directly communicates via the VPN is assigned a public IP address. Other devices in managed network 300 and/or computational instance 322 may be assigned private IP addresses (e.g., IP addresses selected from the 10.0.0.0-10.255.255.255 or 192.168.0.0-192.168.255.255 ranges, represented in shorthand as subnets 10.0.0.0/8 and 192.168.0.0/16, respectively).

### IV. Example Device, Application, and Service Discovery

In order for remote network management platform 320 to administer the devices, applications, and services of managed network 300, remote network management platform 320 may first determine what devices are present in managed network 300, the configurations and operational statuses of these devices, and the applications and services provided by the devices, as well as the relationships between discovered devices, applications, and services. As noted above, each device, application, service, and relationship may be referred to as a configuration item. The process of defining configuration items within managed network 300 is referred to as discovery, and may be facilitated at least in part by proxy servers 312.

For purposes of the embodiments herein, an “application” may refer to one or more processes, threads, programs, client modules, server modules, or any other software that executes on a device or group of devices. A “service” may refer to a high-level capability provided by multiple applications executing on one or more devices working in conjunction with one another. For example, a high-level web service may involve multiple web application server threads executing on one device and accessing information from a database application that executes on another device.

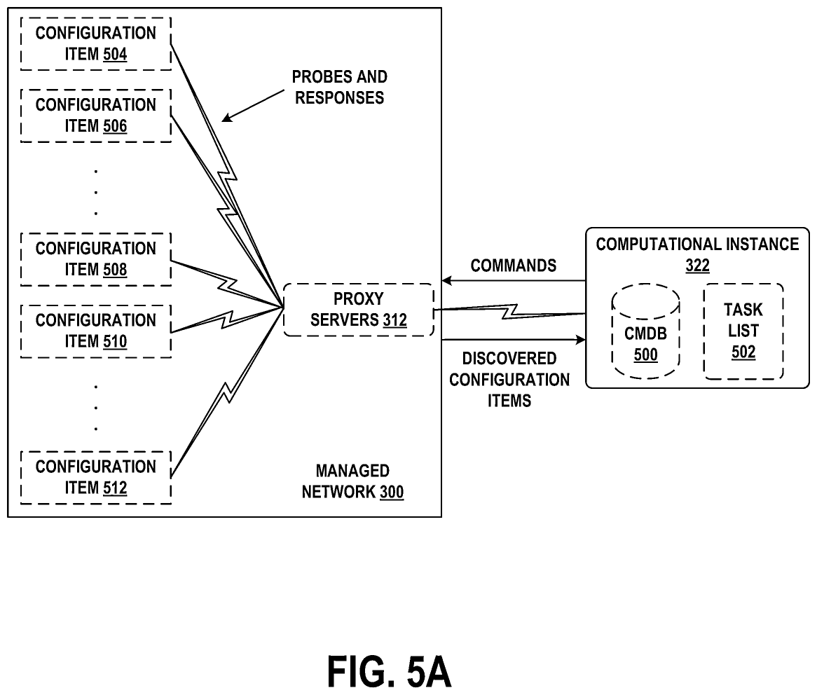

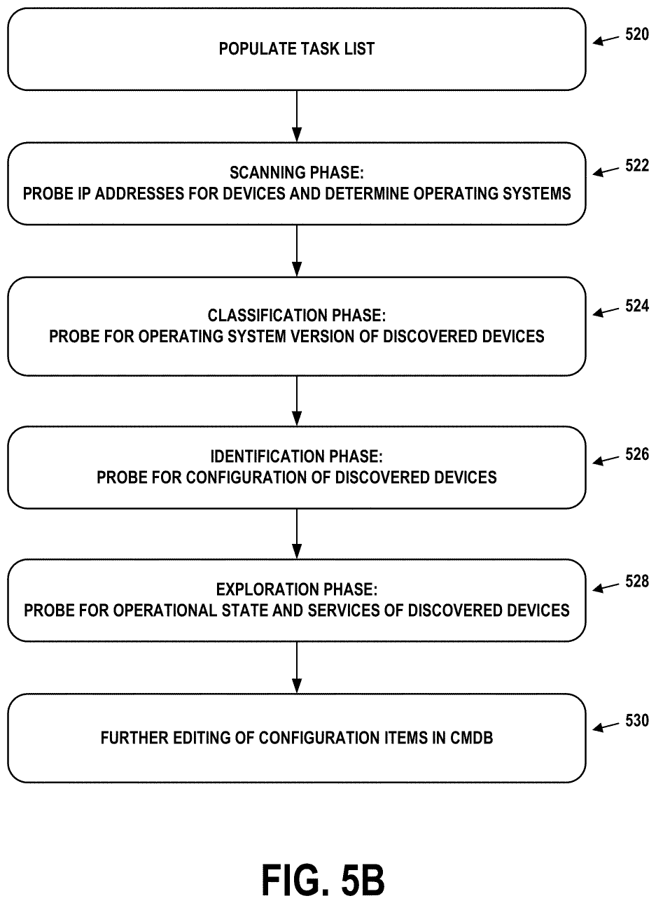

FIG. 5A provides a logical depiction of how configuration items can be discovered, as well as how information related to discovered configuration items can be stored. For sake of simplicity, remote network management platform 320, public cloud networks 340, and Internet 350 are not shown.

In FIG. 5A, CMDB 500 and task list 502 are stored within computational instance 322. Computational instance 322 may transmit discovery commands to proxy servers 312. In response, proxy servers 312 may transmit probes to various devices, applications, and services in managed network 300. These devices, applications, and services may transmit responses to proxy servers 312, and proxy servers 312 may then provide information regarding discovered configuration items to CMDB 500 for storage therein. Configuration items stored in CMDB 500 represent the environment of managed network 300.

Task list 502 represents a list of activities that proxy servers 312 are to perform on behalf of computational instance 322. As discovery takes place, task list 502 is populated. Proxy servers 312 repeatedly query task list 502, obtain the next task therein, and perform this task until task list 502 is empty or another stopping condition has been reached.

To facilitate discovery, proxy servers 312 may be configured with information regarding one or more subnets in managed network 300 that are reachable by way of proxy servers 312. For instance, proxy servers 312 may be given the IP address range 192.168.0/24 as a subnet. Then, computational instance 322 may store this information in CMDB 500 and place tasks in task list 502 for discovery of devices at each of these addresses.

FIG. 5A also depicts devices, applications, and services in managed network 300 as configuration items 504, 506, 508, 510, and 512. As noted above, these configuration items represent a set of physical and/or virtual devices (e.g., client devices, server devices, routers, or virtual machines), applications executing thereon (e.g., web servers, email servers, databases, or storage arrays), relationships therebetween, as well as services that involve multiple individual configuration items.

Placing the tasks in task list 502 may trigger or otherwise cause proxy servers 312 to begin discovery. Alternatively or additionally, discovery may be manually triggered or automatically triggered based on triggering events (e.g., discovery may automatically begin once per day at a particular time).

In general, discovery may proceed in four logical phases: scanning, classification, identification, and exploration. Each phase of discovery involves various types of probe messages being transmitted by proxy servers 312 to one or more devices in managed network 300. The responses to these probes may be received and processed by proxy servers 312, and representations thereof may be transmitted to CMDB 500. Thus, each phase can result in more configuration items being discovered and stored in CMDB 500.

In the scanning phase, proxy servers 312 may probe each IP address in the specified range of IP addresses for open Transmission Control Protocol (TCP) and/or User Datagram Protocol (UDP) ports to determine the general type of device. The presence of such open ports at an IP address may indicate that a particular application is operating on the device that is assigned the IP address, which in turn may identify the operating system used by the device. For example, if TCP port 135 is open, then the device is likely executing a WINDOWS® operating system. Similarly, if TCP port 22 is open, then the device is likely executing a UNIX® operating system, such as LINUX®. If UDP port 161 is open, then the device may be able to be further identified through the Simple Network Management Protocol (SNMP). Other possibilities exist. Once the presence of a device at a particular IP address and its open ports have been discovered, these configuration items are saved in CMDB 500.

In the classification phase, proxy servers 312 may further probe each discovered device to determine the version of its operating system. The probes used for a particular device are based on information gathered about the devices during the scanning phase. For example, if a device is found with TCP port 22 open, a set of UNIX®-specific probes may be used. Likewise, if a device is found with TCP port 135 open, a set of WINDOWS®-specific probes may be used. For either case, an appropriate set of tasks may be placed in task list 502 for proxy servers 312 to carry out. These tasks may result in proxy servers 312 logging on, or otherwise accessing information from the particular device. For instance, if TCP port 22 is open, proxy servers 312 may be instructed to initiate a Secure Shell (SSH) connection to the particular device and obtain information about the operating system thereon from particular locations in the file system. Based on this information, the operating system may be determined. As an example, a UNIX® device with TCP port 22 open may be classified as AIX®, HPUX, LINUX®, MACOS®, or SOLARIS®. This classification information may be stored as one or more configuration items in CMDB 500.

In the identification phase, proxy servers 312 may determine specific details about a classified device. The probes used during this phase may be based on information gathered about the particular devices during the classification phase. For example, if a device was classified as LINUX®, a set of LINUX®-specific probes may be used. Likewise, if a device was classified as WINDOWS® 2012, as a set of WINDOWS®-2012-specific probes may be used. As was the case for the classification phase, an appropriate set of tasks may be placed in task list 502 for proxy servers 312 to carry out. These tasks may result in proxy servers 312 reading information from the particular device, such as basic input/output system (BIOS) information, serial numbers, network interface information, media access control address(es) assigned to these network interface(s), IP address(es) used by the particular device and so on. This identification information may be stored as one or more configuration items in CMDB 500.

In the exploration phase, proxy servers 312 may determine further details about the operational state of a classified device. The probes used during this phase may be based on information gathered about the particular devices during the classification phase and/or the identification phase. Again, an appropriate set of tasks may be placed in task list 502 for proxy servers 312 to carry out. These tasks may result in proxy servers 312 reading additional information from the particular device, such as processor information, memory information, lists of running processes (applications), and so on. Once more, the discovered information may be stored as one or more configuration items in CMDB 500.

Running discovery on a network device, such as a router, may utilize SNMP. Instead of or in addition to determining a list of running processes or other application-related information, discovery may determine additional subnets known to the router and the operational state of the router's network interfaces (e.g., active, inactive, queue length, number of packets dropped, etc.). The IP addresses of the additional subnets may be candidates for further discovery procedures. Thus, discovery may progress iteratively or recursively.

Once discovery completes, a snapshot representation of each discovered device, application, and service is available in CMDB 500. For example, after discovery, operating system version, hardware configuration, and network configuration details for client devices, server devices, and routers in managed network 300, as well as applications executing thereon, may be stored. This collected information may be presented to a user in various ways to allow the user to view the hardware composition and operational status of devices, as well as the characteristics of services that span multiple devices and applications.

Furthermore, CMDB 500 may include entries regarding dependencies and relationships between configuration items. More specifically, an application that is executing on a particular server device, as well as the services that rely on this application, may be represented as such in CMDB 500. For example, suppose that a database application is executing on a server device, and that this database application is used by a new employee onboarding service as well as a payroll service. Thus, if the server device is taken out of operation for maintenance, it is clear that the employee onboarding service and payroll service will be impacted. Likewise, the dependencies and relationships between configuration items may be able to represent the services impacted when a particular router fails.

In general, dependencies and relationships between configuration items may be displayed on a web-based interface and represented in a hierarchical fashion. Thus, adding, changing, or removing such dependencies and relationships may be accomplished by way of this interface.

Furthermore, users from managed network 300 may develop workflows that allow certain coordinated activities to take place across multiple discovered devices. For instance, an IT workflow might allow the user to change the common administrator password to all discovered LINUX® devices in a single operation.

In order for discovery to take place in the manner described above, proxy servers 312, CMDB 500, and/or one or more credential stores may be configured with credentials for one or more of the devices to be discovered. Credentials may include any type of information needed in order to access the devices. These may include userid/password pairs, certificates, and so on. In some embodiments, these credentials may be stored in encrypted fields of CMDB 500. Proxy servers 312 may contain the decryption key for the credentials so that proxy servers 312 can use these credentials to log on to or otherwise access devices being discovered.

The discovery process is depicted as a flow chart in FIG. 5B. At block 520, the task list in the computational instance is populated, for instance, with a range of IP addresses. At block 522, the scanning phase takes place. Thus, the proxy servers probe the IP addresses for devices using these IP addresses, and attempt to determine the operating systems that are executing on these devices. At block 524, the classification phase takes place. The proxy servers attempt to determine the operating system version of the discovered devices. At block 526, the identification phase takes place. The proxy servers attempt to determine the hardware and/or software configuration of the discovered devices. At block 528, the exploration phase takes place. The proxy servers attempt to determine the operational state and applications executing on the discovered devices. At block 530, further editing of the configuration items representing the discovered devices and applications may take place. This editing may be automated and/or manual in nature.

The blocks represented in FIG. 5B are examples. Discovery may be a highly configurable procedure that can have more or fewer phases, and the operations of each phase may vary. In some cases, one or more phases may be customized, or may otherwise deviate from the exemplary descriptions above.

In this manner, a remote network management platform may discover and inventory the hardware, software, and services deployed on and provided by the managed network. As noted above, this data may be stored in a CMDB of the associated computational instance as configuration items. For example, individual hardware components (e.g., computing devices, virtual servers, databases, routers, etc.) may be represented as hardware configuration items, while the applications installed and/or executing thereon may be represented as software configuration items.

The relationship between a software configuration item installed or executing on a hardware configuration item may take various forms, such as “is hosted on”, “runs on”, or “depends on”. Thus, a database application installed on a server device may have the relationship “is hosted on” with the server device to indicate that the database application is hosted on the server device. In some embodiments, the server device may have a reciprocal relationship of “used by” with the database application to indicate that the server device is used by the database application. These relationships may be automatically found using the discovery procedures described above, though it is possible to manually set relationships as well.

The relationship between a service and one or more software configuration items may also take various forms. As an example, a web service may include a web server software configuration item and a database application software configuration item, each installed on different hardware configuration items. The web service may have a “depends on” relationship with both of these software configuration items, while the software configuration items have a “used by” reciprocal relationship with the web service. Services might not be able to be fully determined by discovery procedures, and instead may rely on service mapping (e.g., probing configuration files and/or carrying out network traffic analysis to determine service level relationships between configuration items) and possibly some extent of manual configuration.

Regardless of how relationship information is obtained, it can be valuable for the operation of a managed network. Notably, IT personnel can quickly determine where certain software applications are deployed, and what configuration items make up a service. This allows for rapid pinpointing of root causes of service outages or degradation. For example, if two different services are suffering from slow response times, the CMDB can be queried (perhaps among other activities) to determine that the root cause is a database application that is used by both services having high processor utilization. Thus, IT personnel can address the database application rather than waste time considering the health and performance of other configuration items that make up the services.

### V. CMDB Identification Rules and Reconciliation

A CMDB, such as CMDB 500, provides a repository of configuration items, and when properly provisioned, can take on a key role in higher-layer applications deployed within or involving a computational instance. These applications may relate to enterprise IT service management, operations management, asset management, configuration management, compliance, and so on.

For example, an IT service management application may use information in the CMDB to determine applications and services that may be impacted by a component (e.g., a server device) that has malfunctioned, crashed, or is heavily loaded. Likewise, an asset management application may use information in the CMDB to determine which hardware and/or software components are being used to support particular enterprise applications. As a consequence of the importance of the CMDB, it is desirable for the information stored therein to be accurate, consistent, and up to date.

A CMDB may be populated in various ways. As discussed above, a discovery procedure may automatically store information related to configuration items in the CMDB. However, a CMDB can also be populated, as a whole or in part, by manual entry, configuration files, and third-party data sources. Given that multiple data sources may be able to update the CMDB at any time, it is possible that one data source may overwrite entries of another data source. Also, two data sources may each create slightly different entries for the same configuration item, resulting in a CMDB containing duplicate data. When either of these occurrences takes place, they can cause the health and utility of the CMDB to be reduced.

In order to mitigate this situation, these data sources might not write configuration items directly to the CMDB. Instead, they may write to an identification and reconciliation application programming interface (API). This API may use a set of configurable identification rules that can be used to uniquely identify configuration items and determine whether and how they are written to the CMDB.

In general, an identification rule specifies a set of configuration item attributes that can be used for this unique identification. Identification rules may also have priorities so that rules with higher priorities are considered before rules with lower priorities. Additionally, a rule may be independent, in that the rule identifies configuration items independently of other configuration items. Alternatively, the rule may be dependent, in that the rule first uses a metadata rule to identify a dependent configuration item.

Metadata rules describe which other configuration items are contained within a particular configuration item, or the host on which a particular configuration item is deployed. For example, a network directory service configuration item may contain a domain controller configuration item, while a web server application configuration item may be hosted on a server device configuration item.

A goal of each identification rule is to use a combination of attributes that can unambiguously distinguish a configuration item from all other configuration items, and is expected not to change during the lifetime of the configuration item. Some possible attributes for an example server device may include serial number, location, operating system, operating system version, memory capacity, and so on. If a rule specifies attributes that do not uniquely identify the configuration item, then multiple components may be represented as the same configuration item in the CMDB. Also, if a rule specifies attributes that change for a particular configuration item, duplicate configuration items may be created.

Thus, when a data source provides information regarding a configuration item to the identification and reconciliation API, the API may attempt to match the information with one or more rules. If a match is found, the configuration item is written to the CMDB. If a match is not found, the configuration item may be held for further analysis.

Configuration item reconciliation procedures may be used to ensure that only authoritative data sources are allowed to overwrite configuration item data in the CMDB. This reconciliation may also be rules-based. For instance, a reconciliation rule may specify that a particular data source is authoritative for a particular configuration item type and set of attributes. Then, the identification and reconciliation API will only permit this authoritative data source to write to the particular configuration item, and writes from unauthorized data sources may be prevented. Thus, the authorized data source becomes the single source of truth regarding the particular configuration item. In some cases, an unauthorized data source may be allowed to write to a configuration item if it is creating the configuration item or the attributes to which it is writing are empty.

Additionally, multiple data sources may be authoritative for the same configuration item or attributes thereof. To avoid ambiguities, these data sources may be assigned precedences that are taken into account during the writing of configuration items. For example, a secondary authorized data source may be able to write to a configuration item's attribute until a primary authorized data source writes to this attribute. Afterward, further writes to the attribute by the secondary authorized data source may be prevented.

In some cases, duplicate configuration items may be automatically detected by reconciliation procedures or in another fashion. These configuration items may be flagged for manual de-duplication.

### VI. Example Network Service as a Graph

The discovery procedures described herein are particularly helpful in generating network maps. A network map may be a visual representation on a GUI, for instance, that depicts particular applications operating on particular devices as nodes in a graph. The edges of the graph may represent physical and/or logical network connectivity between these nodes. An instance of a network map may be derived from a portion of the data in a CMDB and tailored to represent the devices and applications that make up or contribute to the operation of a service.

Discovery procedures may be used to determine the physical or logical arrangement of devices on a managed network, as well as the applications operating on these devices. Discovery procedures may also determine the relationships between these devices and applications, such as those that define services. Alternatively or additionally, services may be manually defined after discovery has at least partially completed. From this information, a network map can be derived.

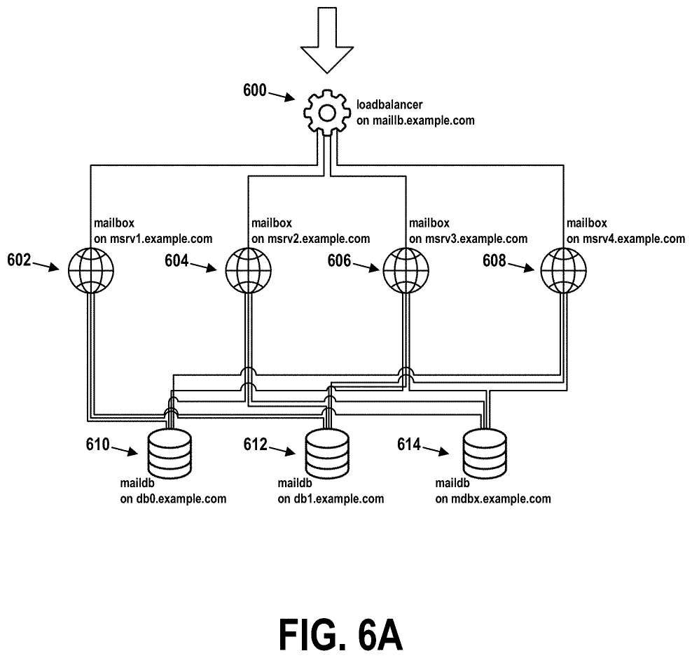

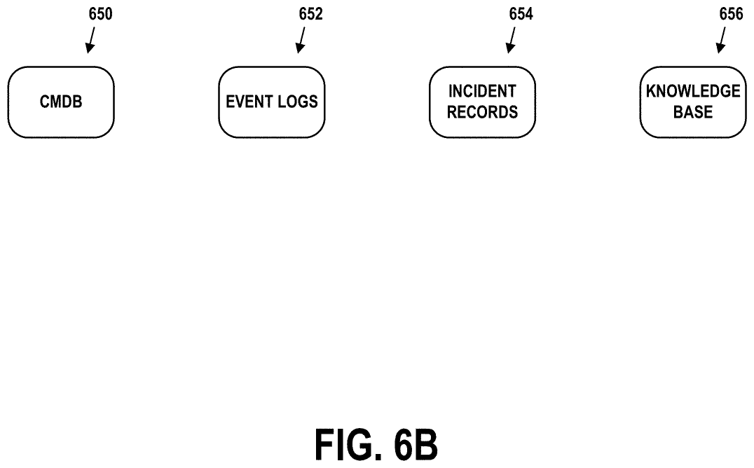

FIG. 6 provides an example graph of a network map including applications and devices that make up an email service that supports redundancy and high-availability. This graph may be generated for display on the screen of a computing device. As noted above, the nodes in the graph (i.e., nodes 600, 602, 604, 606, 608, 610, 612, and 614) represent applications operating on devices. Visually, these nodes may take the form of icons related to the respective functions of the applications or devices. The edges in the graph represent relationships between the nodes (e.g., “is hosted on”, “runs on”, “depends on”, or “used by”), though specific types of relationships are omitted from FIG. 6 to avoid clutter. For purposes of the internal graph representation and manipulation thereof, the visual depictions of nodes as icons and edges as lines is not relevant—other visual depictions may be used.

The entry point to the email service, as designated by the large downward-pointing arrow, may be load balancer 600 (“loadbalancer”). Load balancer 600 may be represented with a gear icon, and may operate on a device with host name maillb.example.com. This host name, as well as other host names herein, may be a partially-qualified or fully-qualified domain name in accordance with DNS domain syntax.

Load balancer 600 may distribute incoming requests across mailbox applications 602, 604, 606, and 608 (“mailbox”) operating on mail server devices msrv1.example.com, msrv2.example.com, msrv3.example.com, and msrv4.example.com, respectively. These mail server devices may be represented by globe icons on the graph. Connectivity between load balancer 600 and each of mailbox applications 602, 604, 606, and 608 is represented by respective edges.

Mailbox applications 602, 604, 606, and 608 may, for instance, respond to incoming requests for the contents of a user's mail folder, for the content of an individual email message, to move an email message from one folder to another, or to delete an email message. Mailbox applications 602, 604, 606, and 608 may also receive and process incoming emails for storage by the email service. Other email operations may be supported by mailbox applications 602, 604, 606, and 608. For sake of example, it may be assumed that mailbox applications 602, 604, 606, and 608 perform essentially identical operations, and any one of these applications may be used to respond to any particular request.

The actual contents of users' email accounts, including email messages, folder arrangements, and other settings, may be stored in one or more of mail database applications 610, 612, and 614 (“maildb”). These applications may operate on database server devices db0.example.com, db1.example.com, and mdbx.example.com, which are represented by database icons on the map and are also nodes in the underlying graph. Connectivity between mailbox applications 602, 604, 606, and 608 and each of mail database applications 610, 612, and 614 also is represented by respective edges.

Mailbox applications 602, 604, 606, and 608 may retrieve requested data from mail database applications 610, 612, and 614, and may also write data to mail database applications 610, 612, and 614. The data stored by mail database applications 610, 612, and 614 may be replicated across all of the database server devices.

As an example of the operation of the email service depicted by the graph of FIG. 6, an incoming email message may arrive at load balancer 600. This email message may be addressed to an email account (e.g., user@example.com) supported by the email service. Load balancer 600 may select one of mailbox applications 602, 604, 606, and 608 to store the email message. For instance, load balancer 600 may make this selection based on a round-robin procedure, the loads (e.g., CPU, memory, and/or network utilization) reported by mailbox applications 602, 604, 606, and 608, randomly, or some combination thereof.

Assuming that load balancer 600 selects mailbox application 604, load balancer 600 then transmits the email message to mailbox application 604. Mailbox application 604 may perform any necessary mail server functions to process the email message, such as verifying that the addressee is supported by the email server, validating the source of the email message, running the email message through a spam filter, and so on. After these procedures, mailbox application 604 may select one of mail database applications 610, 612, and 614 for storage of the email message. Similar to load balancer 600, mailbox application 604 may make this selection based on various criteria, including load on mail database applications 610, 612, and 614.

Assuming that mailbox application 604 selects mail database application 610, mailbox application 604 then transmits the email message to mail database application 610. Mail database application 610 may perform any necessary mail database functions to process and store the email message. For instance, mail database application 610 may store the message as a compressed file in a file system, and update one or more database tables to represent characteristics of the email message (e.g., the sender, the size of the message, its importance, where the file is stored, and so on).

When a mail client application (not shown) requests a copy of the email message, this request may also be received by load balancer 600. Load balancer 600 may select one of mailbox applications 602, 604, 606, and 608 to retrieve the email message. This selection may be made according to various criteria, such as any of those discussed above. Assuming that load balancer 600 selects mailbox application 608, mailbox application 608 then selects one of mail database applications 610, 612, and 614. Assuming that mailbox application 608 selects mail database application 612, mailbox application 608 requests the email message from mail database application 612.

Since data is replicated across mail database applications 610, 612, and 614, mail database application 612 is able to identify and retrieve the requested email message. For instance, mail database application 612 may look up the email message in a database table, from the table determine where the email message is stored in its file system, find the email message in the file system, and provide the email message to mailbox application 608. Mailbox application 608 may then transmit the email message to the mail client application.

The arrangement of the graph in FIG. 6 may vary. For example, more or fewer load balancers, mailbox applications, mail database applications, as well as their associated devices, may be present. Furthermore, additional devices may be included, such as storage devices, routers, switches, and so on. Additionally, while FIG. 6 is focused on an example email service, similar network graphs may be generated and displayed for other types of services, such as web services, remote access services, automatic backup services, content delivery services, and so on.

VII. Example Databases and/or Data Sources

Despite the power and flexibility of a CMDB and the data stored therein, it is not the only type of database or data source that be can be used for causal analysis. Other types of data may be collected in various ways by a managed network and/or a remote network management platform.

Examples of such databases and data sources are shown in FIG. 6B. In addition to CMDB 650, these may include event logs 652, incident records 654, and knowledgebase 656.

As noted, CMDB 650 may be populated manually or by way of discovery procedures. Each discovered configuration item might represent a device, a software application, or some related aspect. Further, each configuration item may be stored with a number of attributes that define or describe the configuration item. For example, each of the nodes in FIG. 6A may be distinct configuration items. Notably, CMDB 650 may be the same or similar to CMDB 500 shown in FIG. 5A, and therefore may have similar or the same properties and capabilities.

Event logs 652 may include one or more different types of database or other structure that contains entries related to events that have occurred on devices associated with a managed network. Some event logs may record device level events, such as the initiation of a physical or virtual server device. Other of event logs may record software application level events, such as the activities of a particular program executing on one of these devices. Each entry in event logs 652 may be in text or binary format, may include a timestamp of when the event occurred, and may indicate a respective severity, such as informational, warning, error, and so on. A remote network management platform may obtain (e.g., by way of discovery or other processes) copies of at least parts of event logs from a managed network.

Incident records 654 may include textual or binary descriptions of issues, problems, or errors experienced by users of a managed network. These records may be created by the users as or after they experience the incidents, automatically, or by another party. Each record may include a short description of the incident, a longer, more detailed description, a timestamp of when the incident occurred or when the record was created. In some cases, records may identify certain configuration items that are related to (or believed to be related to) the identified incidents.

Knowledgebase 656 may include a corpus of articles, tutorials, frequently asked questions, and other information that is related to the operation of a managed network. These items may be read by users or IT agents who are seeking to carry out certain technological tasks (e.g., setting up a Wifi router, resetting a password, downloading approved software, etc.).

All of these databases and data sources may be indexed and searchable. Further, and as noted above, they may cross-reference one another. Thus, for example, a configuration item may be specified in an event log entry and an incident record by its CMDB identifier.

### VIII. Causal Analysis

One or more of the data sources depicted in FIG. 6B may be used to infer a causal relationship between configuration item states, events, incidents, and/or other information. For example, when a failure occurs on load balancer 600 of FIG. 6A, the root cause may be due to load balancer 600 itself, or any of mailbox applications 602, 604, 606, or 608, any of mail database applications 610, 612, or 614, and/or other devices or software applications not shown. The relationships stored in a CMDB, may not fully capture all of the dependencies that could contribute to such a failure.

The embodiments herein, therefore, generate causal graphs from any one or more of the data sources of FIG. 6B. The inferred graph structure that can be constructed from a CMDB can be used in this process but is not necessary. Thus, the attribute data from configuration items might or might not be used with data from any of the other data sources.

This section provides a theoretical framework for graph-based causal analysis that has certain provable advantages over previous techniques. Once these properties are established, applications to root cause analysis in managed networks are discussed.

A. Causal Relationships

Causal relationships between certain types of entities tend to be more plausible in some directions than in others. For example, the altitude of a city may influence its temperature and the state of a switch may influence whether a light bulb is on or off. However, these causal relationships do not hold in the reverse directions. That is, the temperature of a city does not influence its altitude and whether a light bulb is on or off does not influence the state of its switch. These examples are simple and intuitive.

Nonetheless, the elucidation of causal relationships often goes beyond human intuition. The abundance of large-scale scientific endeavors to understand the causes of diseases or natural phenomena are good examples. In such cases, computational methods for causal analysis may help reveal causal relationships based on patterns of association in data that would be difficult for humans to find much less to intuitively reason about.

Formally, a causal relationship exists from variable Xᵢ to variable Xⱼ if the value of Xⱼ can change in response to changes in Xᵢ This relationship is unidirectional in that it is silent about whether Xᵢ can change in response to changes to Xⱼ. In practice, it is often assumed or known that when a causal relationship exists from Xᵢ to Xⱼ, there is no causal relationship in the other direction.

Causal relationships can be represented as a directed acyclic graph (DAG) where vertices correspond to variables of interest and directed edges indicate causal relationships. Thus, in a DAG, each parent is a cause of all of its children. Additional assumptions, like the faithfulness condition (see below), are then made to enable reasoning about graph structures based on conditional independences in the data. While these enable data-driven causal analysis, the underlying causal graph can only be identified up to its Markov equivalence class (a set of DAGs representing the same distributions of variables as the underlying “ground truth” DAG that is sought), which can often be very large thus leaving many edges un-oriented.

The embodiments herein establish that prior knowledge (e.g., from a human expert or learned from discovery procedures) about the nature of the variables associated with nodes of a DAG can help reduce the size of such equivalence classes. In particular, nodes can be labeled with types based on such prior knowledge. Then, assumptions on how nodes of various types can interact with each other can be asserted, which constrains the space of possible graphs and leads to reduced equivalence classes. As a consequence, both theoretical and empirical results indicate that, when such assumptions hold in the data, significant gains in the identification of underlying causal relationships can be made.

These results can be used, for example, with data on a remote network management platform (e.g., in a CMDB, event logs, incident records, knowledgebase, and/or some other data source) to improve managed network fault detection and root cause analysis. Nonetheless, other applications are possible, such as estimation of the effects of medical treatments on a population of patients.

B. Formal Problem Definition

Let X=(X₁, . . . , X_{d}) be a vector with probability distribution P_{X}. Let G=(V, E) be a DAG with vertices V={v₁, . . . , v_{d}}. Each vertex vᵢ∈V is associated with a variable Xᵢ∈X, and a directed edge (vᵢ, vⱼ)∈E represents a causal relationship from Xᵢ to Xⱼ. Thus, X may represent values of attributes, fields, entries, and so on found in various data sources available to the remote network management platform.

It is assumed that P_{X} can be factorized according to G, that is:

$$p ( {x}_{1} , … , {x}_{d} ) = {\prod }_{k = 1}^{d} p ( {x}_{k} \vert {φ}_{k}^{G} )$$

Where φₖ^{G} denotes the parents of Xₖ∈G, i.e., the one or more parents of the vertex vₖ that corresponds to Xₖ. This relationship is also referred to as a Bayesian network factorization, where each variable is conditioned on its parents in the graph. In other words, G can be generated from P_{X} to represent how causality flows from parent vertices to their respective child vertices. Herein, the vertices V and the variables X may be referred to interchangeably due to the one-to-one relationships therebetween.

From G, it is possible to answer causal questions (e.g., via do-calculus). However, in many situations, the structure of G is unknown and must be inferred from data. The task of causal analysis consists of learning the structure of G based on observations from P_{X}. Some assumptions based on the causal graphical model (CGM) framework are made in order to do so.

Assumption 1 is causal sufficiency, which states there is no unobserved variable that has a causal effect on more than one variable in X.

Assumption 2 is the causal Markov assumption, which can be expressed as:

Xᵢ⊥_{G}Xⱼ|Z⇒Xᵢ⊥_{P}_{_{X}}Xⱼ|Z

Where ⊥ is the conditional independence symbol, and Z is a set composed of variables in X. The property Xᵢ⊥_{G}Xⱼ|Z indicates that Xᵢ and Xⱼ are d-separated by Z in G (here, d-separation means that all the paths in the graph between Xᵢ and Xⱼ are blocked by all vertices in Z). Note that the d in d-separated is not the same as the d used to represent the number of vertices in G.

Assumption 3 is faithfulness, which can be expressed as:

Xᵢ⊥_{P}_{_{X}}Xⱼ|Z⇒Xᵢ⊥_{G}Xⱼ|Z

Thus, conditional independences in the data can be used to learn about d-separations in G. This implies that the causal graph G can be learned from the conditional dependency structure of X.

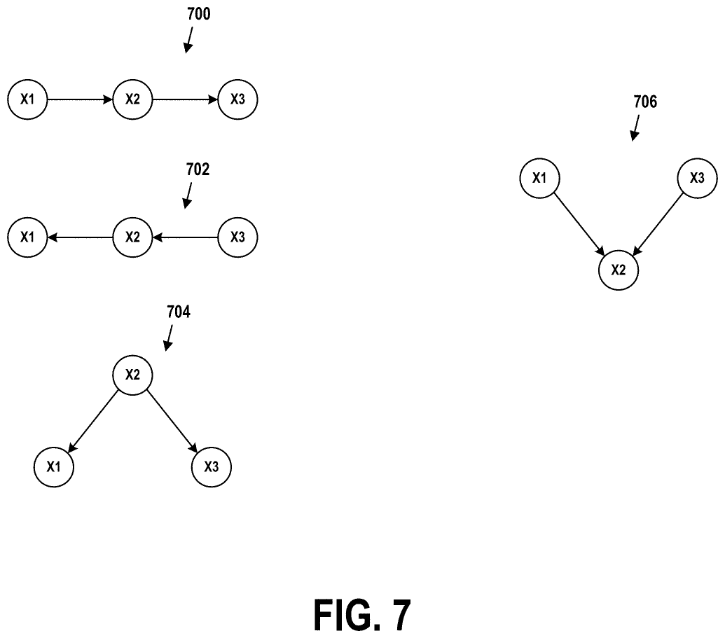

Even with these assumptions, G can only be determined up to its Markov equivalence class (MEC), which is a set containing all the DAGs that can represent the same conditional independencies as G. For example, FIG. 7 depicts four different DAG structures with three vertices. In each, the edges represent dependencies. For example, in DAG 700, the value X2 of the middle vertex is a direct cause of the value X1 of the left vertex, while the value X3 of the right vertex is a direct cause of the value X2 of the middle vertex. The dependency structure of DAGs 700 and 702 are in the form of chains, and the dependency structure of DAG 704 is in the form of a fork. The dependency structure of DAG 706 is in the form of an immorality. It can be shown that if assumptions 1, 2, and 3 hold, then DAGs 700, 702, and 704 form an MEC, while DAG 706 is in its own different MEC. This implies that, given X, it is not always possible to determine the precise underlying causality structure.

A MEC is often characterized graphically using an essential graph or Completed Partially Directed Acyclic Graph (CPDAG), which corresponds to the union of all Markov equivalent DAGs. For instance, the CPDAG for the MEC of DAGs 700, 702, and 704 would involve bidirectional edges between the left vertex and the middle vertex, and between the middle vertex and the right vertex.

For large data sets that are used to form large graphs, the size of the MECs may be unwieldy and prevent root causes of observations (e.g., errors) to be determined. In some cases, e.g., for sparse graphs, the size of the MEC can be huge, significantly limiting inference about the direction of edges in G. Hence, it is desirable to find realistic assumptions to shrink the magnitude of equivalence classes.

The embodiments herein introduce a new approach for doing so, based on background knowledge (e.g., from human experts or discovery), where types are attributed to variables and the interaction between types is constrained. The inclusion of background knowledge in causal analysis aims to reduce the size of the solution space by adding or ruling-out causal relationships based on expert knowledge.

C. Typed DAGs

A typed directed acyclic graph (t-DAG), is a DAG with typed vertices as well as t-edges, which are sets of edges relating vertices of given types. Formal definitions follow.

Definition 1 (t-DAG): A t-DAG is a tuple (V, E) with a mapping T: V→τ such that (V, E) forms a DAG, and T(vᵢ)∈τ is the type of vertex vᵢ∈V, where τ={t₁, . . . , tₖ}. Thus, there are k types of vertices.

Definition 2 (t-edge): A t-edge is a set of edges between vertices of given types in a DAG. Formally, E(t₁, t₂)={(vᵢ, vⱼ)∈E|T(vᵢ)=t₁,T(vⱼ)=t₂} for any pair of types t₁, t₂∈τ. In other words, edges in a t-edge set always extend from a vertex of one particular type to a vertex of another particular type.

Definition 3 (consistent t-DAG): A consistent t-DAG is a t-DAG where, for every t-edge E(t₁, t₂)≠Ø, the property E(t₂, t₁)=Ø holds. This means that if there is an edge from a vertex of a first type to a vertex of a second type, there exists no edges from vertices of the second type to vertices of the first type.

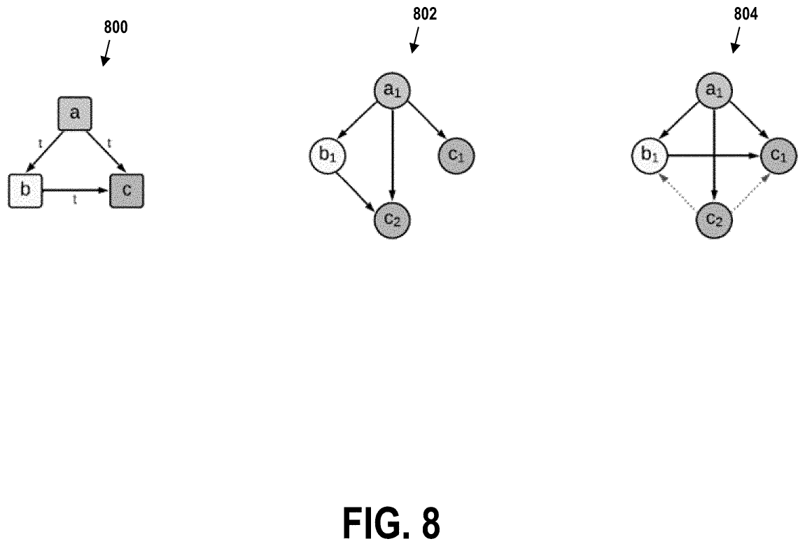

As an example, FIG. 8 depicts edge orientations of three graphs. Graph 800 represents t-edge orientations of a t-DAG in which groups of vertices (each group is depicted as a square) are of different types a, b, and c. Graph 802 is a consistent t-DAG on graph 800 in which vertex a1 is of type a, vertex b1 is of type b, and vertices c1 and c2 are of type c (each vertex is depicted as a circle). Graph 804 is on the same vertices as graph 802, but is not a consistent t-DAG. Particularly, the t-edge E(c, b) contains the edge (c2, b1) while the reverse t-edge E(b, c) is not empty since it contains (b1, c1). Notably, the orientation of all t-edges, summarized in graph 800, fully determines the orientation of edges in a consistent t-DAG.

Alternative assumptions could be considered. For instance, it could be assumed that t-edges form a DAG (i.e. the types have a partial ordering). However, the assumptions considered here are less restrictive and, as shown below, lead to tangible improvements.

The equivalence classes MEC and t-MEC are defined as the set of DAGs and the set of consistent t-DAGs that are Markov equivalent, respectively.

Definition 4 (MEC): The MEC of a t-DAG Dₜ is M(Dₜ)={D′|D′˜Dₜ}, where denotes Markov equivalence. In other words, the MEC for some graph Dₜ consists of all graphs that are Markov equivalent to Dₜ.

Definition 5 (t-MEC): The t-MEC of a consistent t-DAG Dₜ is Mₜ(Dₜ)={Dₜ′|Dₜ′\hat{˜}Dₜ, where \hat{˜} denotes Markov equivalence limited to consistent t-DAGs with the same mapping T as Dₜ.

To represent an equivalence class, an essential graph can be used. This essential graph corresponds to the union of equivalent DAGs.

Definition 6 (Essential graph): The essential graph D* associated with the consistent t-DAG Dₜ is:

D*:=∪_{D∈M(D}_{ₜ}₎D

The union over graphs is defined as the union of their vertices and edges: G₁∪G₂:=(V₁∪V₂, E₁∪E₂). Also, if edge (vᵢ, vⱼ)∈G and its opposite edge (vᵢ, vⱼ)∈G, then the edge between vᵢ and vⱼ is considered to be undirected.

Definition 7: (t-Essential graph): The t-essential graph D*ₜ associated with the consistent t-DAG Dₜ is:

D*ₜ:=∪_{D∈M}_{ₜ}_{(D}_{ₜ}₎D

There are statements that can be made about the space of consistent t-DAGs and the size of t-MECs with respect to their non-typed counterparts. The space of consistent t-DAGs with k types and d vertices, TDAG(k, d), is included in the space of DAGs with the same number of types and vertices, DAG(k, d). Moreover, as stated in proposition 1, for a number of types smaller than the number of vertices, the space of consistent t-DAGs is strictly smaller than that of DAGs.

Proposition 1: TDAG(k,d)⊂DAG(k,d) for k<d, where d is the number of vertices and k is the number of types. In the limit case where k=d, every vertex has a different type, the t-DAG is always consistent, and TDAG(k, d)=DAG(k, d).

The t-essential graph is identical to the essential graph except for the additional edges, which can be oriented thanks to the type consistency assumption. This is summarized in proposition 2.

Proposition 2: Let D*ₜ and D* be, respectively, the t-essential and essential graphs of an arbitrary consistent t-DAG Dₜ. Then Dₜ⊆D*ₜ⊆D*.

From the t-essential graph, there is an upper bound on the size of the t-MEC based on the number of undirected edges.

Proposition 3 (upper bound on the size of the t-MEC): For any consistent t-DAG, Dₜ, the property |Mₜ(Dₜ)|≤2^{u} holds, where u is the number of undirected t-edges in the t-essential graph of Dₜ. From this bound, it can be concluded that if the t-essential graph contains no undirected t-edges, |Mₜ(Dₜ)|=1. In other words, Dₜ can be uniquely identified in this case.

D. Finding the t-Essential Graph

To make practical use of the above definitions, it is desirable to have an algorithm that can recover the t-essential graph based on a set of observational data and their data types. One way of doing so involves use of the PC algorithm and Meek's rules.

1. The PC Algorithm

The PC algorithm is just one possible algorithm for finding an essential graph using independence-based causal discovery. Other algorithms exist. The PC algorithm is defined as follows.

Step 1a: Start with a complete undirected graph, i.e., a graph of the data in which there is an undirected edge between every pair of vertices. Recall that the vertices represent variables (e.g., attributes, values) in the data that has been collected from one or more data sources. This complete graph indicates that the initial assumption is that there are no conditional independencies between the variables (this is true because of the faithfulness assumption).

Step 1b: Using conditional independence tests on the data, identify the skeleton of the graph by removing edges This involves removing edges from Xᵢ to Xⱼ where Xᵢ and Xⱼ are independent based on a conditioning set Z (i.e., Xᵢ⊥Xⱼ|Z). This process occurs starting with an empty conditioning set Z and iteratively increasing its size (e.g., all possible conditioning sets of size 1, all possible conditioning sets of size 2, and so on.). Here, the skeleton is defined as the CPDAG and possibly some additional edges.

Step 1c: Identify and orient immoralities. For any path of undirected edges from Xᵢ to Xⱼ to Xₖ in the graph where (i) there is no edge between Xᵢ and Xₖ, and (ii) Xᵢ was not in the conditioning set that made Xᵢ and Xₖ conditionally independent, then path Xᵢ to Xⱼ to Xₖ forms an immorality where Xᵢ and Xₖ are parents of X₁. Thus, for each identified immorality, the edges thereof can be further oriented by removing any directional edges that are not part of the immorality (i.e., edges from Xᵢ to Xₖ and Xᵢ to Xⱼ are removed).

Step 1d: Orient qualifying undirected edges that are incident on colliders (a collider is a vertex with two or more parents as the result of an immorality—the vertex with value X2 in graph 706 is an example of a collider). Since all colliders have been detected in the previous step, all edges adjacent to a collider that are not part of an immorality can be oriented to point away from the collider (i.e., additional directed edges pointing to the collider are removed). Formally, any undirected edge connecting Xᵢ and Xₖ that is part of a partially directed path Xᵢ to Xᵢ to Xₖ can be changed to a directed edge from Xᵢ to Xₖ, if there is a directed edge from Xᵢ to Xⱼ and no edge connecting Xᵢ and Xₖ.

Note that the variables Xᵢ, Xⱼ, and Xₖ are overloaded between the descriptions of steps 1b, 1c and 1d.

2. Meek's Rules

Meek's rules are a set of four operations that can be used to propagate edge orientations through a graph. A goal is to use these rules to replace undirected edges in the graph with directed edges where appropriate.

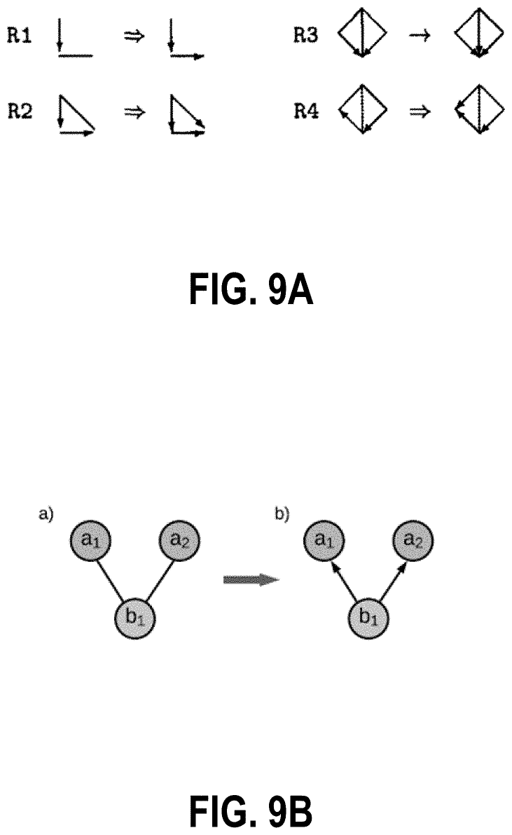

These rules, R1, R2, R3, and R4 are shown in FIG. 9A. Each rule consists of a pair of graph structures. When the structure on the left is found in a graph, it can be replaced with the structure of the right. In each case, this involves replacing an undirected edge with a directed edge.

3. The t-Essential Graph Algorithm

Based on the PC algorithm (or an equivalent) and Meek's rules, one possible embodiment for determining the t-essential graph from a set of observational data and their data types could employ the four following steps:

Step 1: Determine the essential graph (the union of all Markov equivalent DAGs) by applying an algorithm such as PC.

Step 2: Enforce type consistency on the essential graph of step 1. If there exists an oriented edge between any pair of variables with types t₁, t₂∈τ in this graph, then conclude that E(t₁, t₂)≠Ø, i.e., orient all edges between these types as being from type t₁ to type t₂.

Step 3: Apply Meek's rules to propagate the edge orientations derived in step 2.

Step 4: Repeat from step 2 until the graph is unchanged.

This algorithm is sound, in that all edges that it orients are also oriented in the t-essential graph. However, it is not complete because some edges that should be oriented in the t-essential graph will remain un-oriented.

To see this, consider the example of a consistent three-vertex t-DAG that we call the two-type fork (see part a of FIG. 9B). The essential graph for this t-DAG obtained at step 1 would be completely undirected since it contains no immoralities. This would result in a case where none of Meek's rules is applicable and thus, step 2 would not orient any edges. The algorithm would therefore stop and return a fully undirected graph. However, according to the following proposition, the two-type fork should have been oriented.

Proposition 4: If a consistent t-DAG Dₜ contains vertices a₁, a₂, b₁ with types T(a₁)=T(a₂)=a and T(b₁)=b, with edges from b₁ to both a₁ and a₂, then the t-edge from b to a is directed in the t-essential graph. In other words, the direction of causation between types b and a is known.

The intuitive proof of this property is that if the true orientation were a t-edge from a to b, this would create an immorality, which in turn would orient the edges in the essential graph. Because type consistency (Definition 3) is assumed, the only other possible orientation is t-edge from b to a.

Thus, the further orientation rule of FIG. 9B can be added to Meek's rules in order to mitigate this problem. This rule indicates that when there is a fork from a first type of vertex to one or more vertices all of a second type, the direction of causation between these types is known. Nevertheless, adding a rule to orient such structures in step 2, is not sufficient to obtain a complete algorithm. It can be shown that more complex cases (not local and involving multiple t-edges) are not covered, even with this additional orientation rule. Regardless, this addition to Meek's rules can be useful in practical applications.

It remains an open question whether one could design a polynomial-time algorithm to find the t-essential graph. Nonetheless, the following algorithm has a time complexity exponential in the number of types, the computational complexity of which has been found to be non-prohibitive in experiments.

Step A: Run the four steps of the previously described (incomplete) algorithm, adding the two-type fork case to the orientation rules in step 2.

Step B: Enumerate all t-DAGs that can be produced by orienting edges in the graph resulting from the previous step. Reject any inconsistent t-DAG.

Step C: Take the union of all these t-DAGs (see Definition 7) to obtain the t-essential graph.

E. Identification for Random Graphs

There are a number of benefits in identification that result from using variable typing in a class of graphs generated at random based on a process inspired by the Erdos-Renyi random graphs model. Assume that there are k types t₁, . . . , tₖ, with probabilities pᵢ, . . . ,pₖ∈(0,1]^{k} of observing each type, respectively. Thus, p₁+ . . . +pₖ=1. Further, there is a t-interaction matrix A∈[0,1]^{k×k} where each cell (i,j) defines a probability pᵢⱼ that a variable of type tᵢ is a direct cause of a variable of type tᵢ. Due to definition 3 (type consistency), if pᵢⱼ>0, then pⱼᵢ=0.

Definition 8 (random sequence of growing t-DAG): a random sequence of t-DAGs (Dₜⁿ)ₙ₌₀^{∞} with Dₜⁿ=(Vⁿ, Eⁿ) and |Vⁿ|=n, such that Dₜ⁰=(Ø, Ø) can be constructed. Each new t-DAG Dₜⁿ in the sequence is obtained from Dₜⁿ⁻¹ as follows: (i) create a new vertex vₙ and sample its type from a categorical distribution with probabilities p₁, . . . , pₖ; (ii) let Vⁿ=Vⁿ⁻¹∪vₙ; (iii) to obtain Eⁿ, for every vertex vᵢ∈Vⁿ⁻¹, add the edge (vᵢ, vₙ) to Eⁿ⁻¹ with probability p_{T(v}_{ᵢ}_{),T(v}_{ₙ}₎ (recall that the function T provides a mapping from a vertex to its type).

The main theorem below states that as more vertices are added to a random sequence of t-DAGs, the t-DAG become more identifiable.

Theorem 1. Let (Dₜⁿ)ₙ₌₀^{∞} be a random sequence of growing t-DAGs as specified in definition 8. Then the size of the t-MEC converges to 1 exponentially fast, i.e., there exists a C and n₀ such that for all n>nₒ:

P(|Mₜ(Dₜⁿ)|>1)<Ce^{-rn}

Where

$$r = \frac{1}{2} max ( ln ( 1 - {p}_{j} {p}_{ij} ) , ln ( 1 - {p}_{i} ) ) .$$

To provide intuition for the theorem, recall that the t-MEC shrinks every time a t-edge is oriented. In addition, proposition 3 states that a t-edge can be oriented if a two-type fork structure is observed. Thus, as more vertices are added, the probability of observing a two-type fork (proposition 4) for arbitrary type pairs converges to 1. This argument relies on the fact that the number of types k remains constant throughout as the random t-DAG grows.

F. Experimental Results

Experiments were performed to understand how the size of MECs and t-MECs compare. For a given t-DAG, the size of the MEC is obtained by calculating its CPDAG (without considering types) and enumerating all DAGs that do not introduce a cycle or add an immorality. For the same t-DAG, the size of the t-MEC is obtained by applying the algorithm described above.

The t-DAGs were randomly generated according to the process described in definition 8. Let k be the number of types in the t-DAG. Uniform probability is attributed to each type, i.e., pᵢ=1/k.

The t-interaction matrix is defined as follows. For each pair of types (tᵢ, t₁) such that i≠j, the direction of the t-edge is sampled randomly with uniform probability and there is a fixed probability of interaction p, which controls the graph density. For example, if the direction tᵢ to tⱼ is sampled, then Aᵢⱼ=p and Aⱼᵢ=0. In what follows, unless otherwise specified, the number of vertices is 50, the number of types is 10, and the probability of interaction is p=0.2.

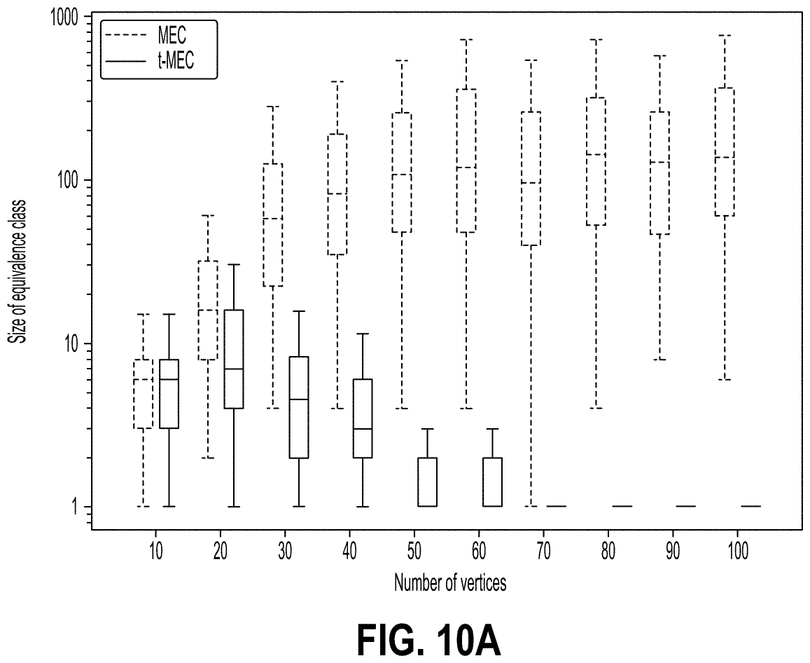

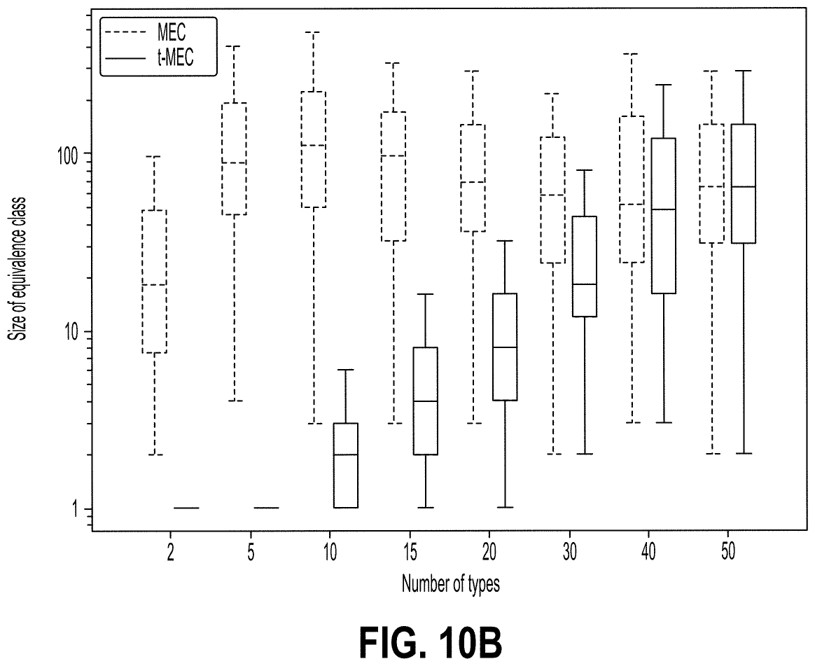

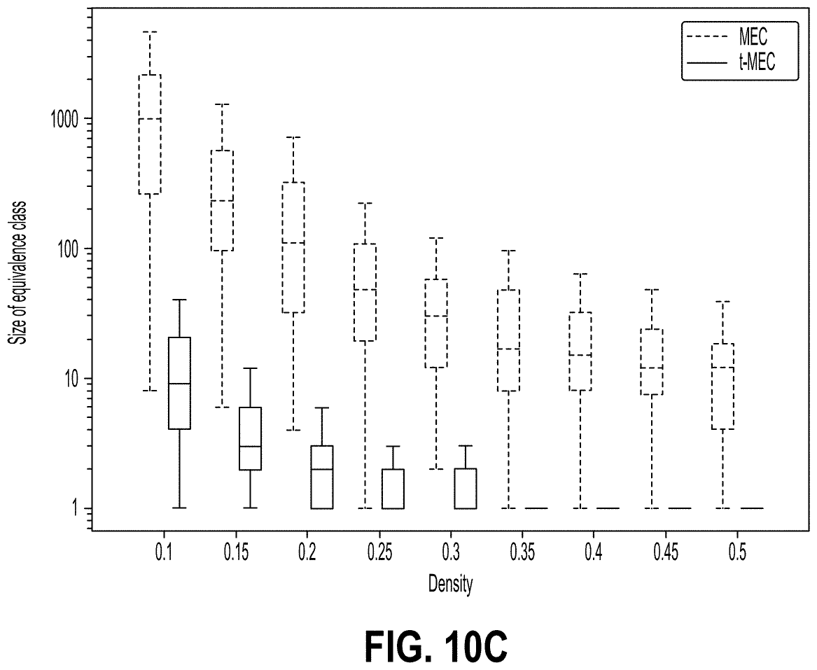

In FIGS. 10A, 10B, and 10C, the size of equivalence classes are compared with respect to the number of vertices, the number of types, and the density, respectively. All boxplots are calculated over 100 random consistent t-DAGs.

FIG. 10A demonstrates that, as the number of vertices increases (and the number of types remains constant), the size of the t-MEC converges to 1, as established above. In contrast, the size of the MEC first increases and then remains near constant. The size of the MEC and the t-MEC are identical when the number of vertices equals the number of types; this is because type consistency does not constrain the graph structure.

FIG. 10B demonstrates that, as the number of types increases, the size of the t-MEC increases. This is expected, because as the number of types approaches the number of vertices, type consistency imposes less structural constraints. Further, the size of the MEC changes with the number of types, even though it is agnostic to type consistency. This is because t-DAGs with fewer types (e.g., 2) are more likely to contain immoralities (see proposition 1), leading to smaller MECs.

FIG. 10C demonstrates that, as the density increases, the size of the MEC and the t-MEC both decrease. This is also in line with theoretical observations.

In summary, all experiments indicate that the size of the t-MEC is smaller or equal to that of the MEC for random t-DAGs. The difference is particularly striking when the number of types is low and the number of vertices is high. Of particular interest are the results shown in FIG. 10A, as they provide empirical evidence for the correctness of Theorem 1.

G. Discussion

In this work, an important problem in causal discovery was addressed: it is often impossible to identify the causal graph precisely, due to the size of its Markov equivalence class. This is particularly true for sparse graphs, where the size of the MEC grows super-exponentially with the number of vertices. In this sense, a new type of assumption was proposed based on data types, which were formalized as typed directed acyclic graphs (t-DAGs). The theoretical and empirical results clearly demonstrate that there exists conditions in which this variable-typing assumption greatly shrinks the size of the equivalence class. Hence, when such assumptions hold in the data, gains in identification are to be expected.

Notably, the new assumptions introduced can be used in conjunction with other strategies to shrink the size of the equivalence class, such as considering interventions, hard background knowledge on the presence/absence of edges, or functional-form assumptions. Moreover, our assumptions could be used with methods that estimate treatment effects from equivalence classes, such as intervention do-calculus when a DAG is absent (IDA), to improve their accuracy.

This work may also be used with machine learning. As machine-learning algorithms excel at classification, the data types can be learned based on some features. Type assignments could be learned in parallel with causal discovery, using methods for differentiable causal discovery. This may further reduce the burden on the human expert in cases where types are hard to assign. As one example, the types of configuration items might be determined by a machine learning classifier if discovery processes and/or manual assignment proves to have insufficient accuracies. As another example, consider the task of learning causal models of gene regulatory networks. One could train a model to assign types to genes based on their categorization in the gene ontology or on features of their DNA sequence.

Additionally, these typing assumptions can be used to perform causal discovery on multiple graphs at once, i.e., multi-task causal discovery. In fact, given data for multiple groups of variables that correspond to disjoint systems (no interactions across groups), but that share similar types, it would be possible to use type consistency (definition 3) to propagate t-edge orientations across graphs.

Therefore, the results herein show that considering typing assumptions has the potential to improve identification in causal discovery.

H. Applications to a Remote Network Management Platform

Based on the discussion above, applying these results to the data obtained or obtainable by a remote network management platform should be apparent. Nonetheless, some specific aspects are provided.

As noted, the data can be from any database or data source, such as a CMDB, event logs, incident reports, and/or a knowledgebase. Some of this data may be explicitly or inherently typed. For example, configuration items in a CMDB are typically assigned a class (e.g., server, virtual machine, router, load balancer, database), events typically have a severity (e.g., informational, warning, error), incident reports typically have several types of categories, and so on. These may be used as types. Given that the number of these types is quite small in comparison to the number of variables/vertices, the results above suggest that t-MECs could be much smaller than the corresponding MECs and, by definition, never larger. This means that ground truth underlying causal relationships are likely to be discovered using these techniques.

The types may be the classes, severities, and/or categories given above, or combinations of device or software application with these types. For example, “types” may be “server:error” or “database:error” representing error events on servers and databases, respectively.

The conditional dependency structure of this data can be inferred. For example, the data may show that within one minute of an event of type A occurring on one computing device, 90% of the time an event of type B occurs on another computing device. Thus, the event of type B may be dependent on the event of type A, and the event of type A may be represented as a variable/vertex in a graph as parent or another form of ancestor of a variable/vertex in the graph representing event B. Another example would be that certain types of incident reports are dependent on other types of events. Timestamps embedded in the data may assist with determining causes and effect, e.g., earlier events may be the causes of later events but causality does not flow in the other direction.

The dependency data may be configured to indicate that events of some types can cause events of other types, but not vice versa. These notions can be generalized to create the t-essential graphs with the beneficial properties described herein.

### IX. Example Operations

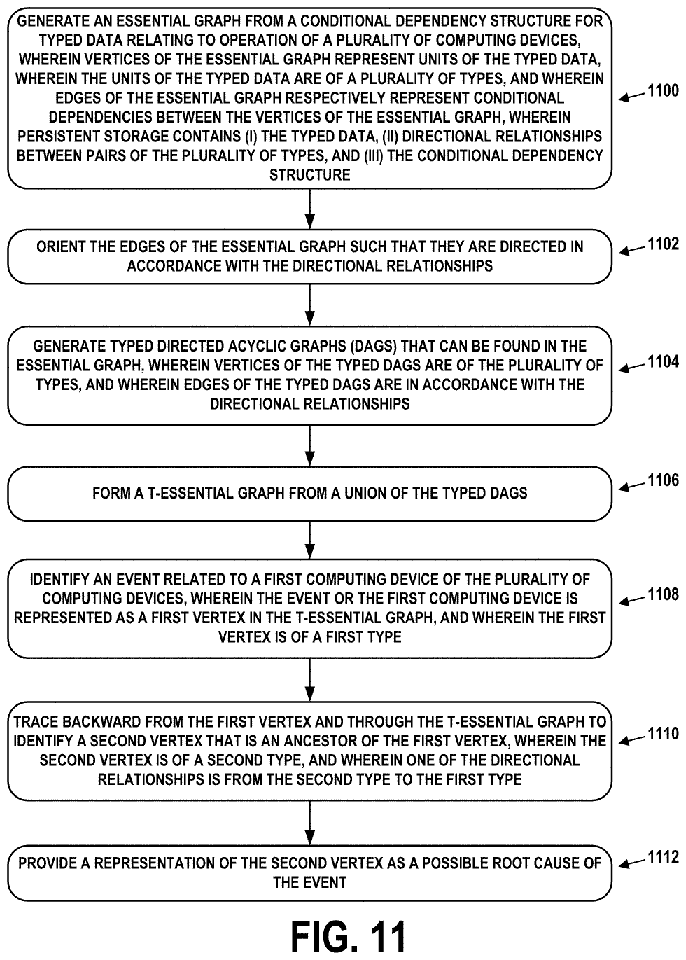

FIG. 11 is a flow chart illustrating an example embodiment. The process illustrated by FIG. 11 may be carried out by a computing device, such as computing device 100, and/or a cluster of computing devices, such as server cluster 200. However, the process can be carried out by other types of devices or device subsystems. For example, the process could be carried out by a computational instance of a remote network management platform or a portable computer, such as a laptop or a tablet device.

The embodiments of FIG. 11 may be simplified by the removal of any one or more of the features shown therein. Further, these embodiments may be combined with features, aspects, and/or implementations of any of the previous figures or otherwise described herein.

Block 1100 may involve generating an essential graph from a conditional dependency structure for typed data relating to operation of a plurality of computing devices, wherein vertices of the essential graph represent units of the typed data, wherein the units of the typed data are of a plurality of types, and wherein edges of the essential graph respectively represent conditional dependencies between the vertices of the essential graph, wherein persistent storage contains (i) the typed data, (ii) directional relationships between pairs of the plurality of types, and (iii) the conditional dependency structure.

Block 1102 may involve orienting the edges of the essential graph such that they are directed in accordance with the directional relationships.

Block 1104 may involve generating typed directed acyclic graphs (DAGs) that can be found in the essential graph, wherein vertices of the typed DAGs are of the plurality of types, and wherein edges of the typed DAGs are in accordance with the directional relationships.

Block 1106 may involve forming a t-essential graph from a union of the typed DAGs.

Block 1108 may involve identifying an event related to a first computing device of the plurality of computing devices, wherein the event or the first computing device is represented as a first vertex in the t-essential graph, and wherein the first vertex is of a first type.

Block 1110 may involve tracing backward from the first vertex and through the t-essential graph to identify a second vertex that is an ancestor of the first vertex, wherein the second vertex is of a second type, and wherein one of the directional relationships is from the second type to the first type. Notably, the root cause of interest is not necessarily a direct parent of the first vertex. Rather, there may be a path of cascading causal relationships, which may all be considered root causes (or one may argue that the root cause is completely at the beginning of the chain). Thus, that the root cause is not necessarily a direct parent. Here, the tracing backward may involve tracing backward through all Markov equivalent t-DAGs, and may result in multiple possible root causes.

Block 1112 may involve providing a representation of the second vertex as a possible root cause of the event.

In some embodiments, a count of the typed DAGs (e.g., those that are Markov equivalent) is less than that of non-typed DAGs that could be generated from the essential graph prior to edge orientation. This may happen when there are less types than vertices, otherwise the count of typed DAGs is less than or equal to that of non-typed DAGs. The count of the typed DAGs may be 1, and if so a single root cause may be uniquely identified.

Some embodiments may further involve: tracing backward from the first vertex and through the t-essential graph to identify a third vertex that is a further ancestor of the first vertex, wherein the third vertex is of the second type; and providing a further representation of third vertex as the possible root cause of the event.

Some embodiments may further involve: tracing backward from the first vertex and through the t-essential graph to identify a third vertex that is a further ancestor of the first vertex, wherein the third vertex is of a third type, and wherein one of the directional relationships is from the third type to the first type; and providing a further representation of third vertex as the possible root cause of the event.

In some embodiments, the typed data represents one or more of events occurring on the plurality of computing devices, classes of the plurality of computing devices, incident reports relating to the plurality of computing devices, or knowledgebase articles relating to the plurality of computing devices.

In some embodiments, the typed data includes references to one or more computing devices of the plurality of computing devices, and wherein the plurality of types include indications of classes of the one or more computing devices.

In some embodiments, the typed data includes references to one or more events that have occurred on the plurality of computing devices, and wherein the plurality of types include indications of types of the one or more events.

In some embodiments, the typed data includes references to one or more incident reports relating to the plurality of computing devices, and wherein the plurality of types include indications of types of the one or more incident reports.

In some embodiments, the conditional dependency structure was generated from the typed data based on types of the typed data and timestamps embedded within the typed data.

In some embodiments, orienting the edges of the essential graph such that they are directed in accordance with the directional relationships comprises replacing undirected edges with directed edges.

In some embodiments, the second vertex has no ancestor in the t-essential graph.

### X. Closing

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical operations or actions in the method or technique. The program code and/or related data can be stored on any type of computer readable medium such as a storage device including RAM, a disk drive, a solid-state drive, or another storage medium.

The computer readable medium can also include non-transitory computer readable media such as non-transitory computer readable media that store data for short periods of time like register memory and processor cache. The non-transitory computer readable media can further include non-transitory computer readable media that store program code and/or data for longer periods of time. Thus, the non-transitory computer readable media may include secondary or persistent long-term storage, like ROM, optical or magnetic disks, solid-state drives, or compact disc read only memory (CD-ROM), for example. The non-transitory computer readable media can also be any other volatile or non-volatile storage systems. A non-transitory computer readable medium can be considered a computer readable storage medium, for example, or a tangible storage device.

Moreover, a step or block that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments could include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

The following is a complete listing of the claims:

1. A system comprising:
a network interface in communication with a plurality of computing devices each having a first configuration;
persistent storage containing: (i) typed data relating to the first configuration of each of the plurality of computing devices, wherein units of the typed data are of a plurality of types, (ii) directional relationships between pairs of the plurality of types, and (iii) a conditional dependency structure for the typed data; and
a management device coupled to the network interface and persistent storage, the management device including one or more processors configured to:
identify an event related to a first computing device of the plurality of computing devices,
in response to the identification of the event, display the conditional dependency structure associated with the plurality of computing devices as an essential graph comprising vertices that represent units of typed data and edges interconnecting the vertices that represent conditional dependencies between the displayed vertices, wherein the edges are directed in accordance with the directional relationships;
generate a t-essential graph from a union of typed directed acyclic graphs (DAGs) identified in the essential graph, wherein vertices of the typed DAGs are of the plurality of types, and wherein edges of the typed DAGs are in accordance with the directional relationships;
trace backward from a first vertex corresponding to the event or the first computing device through the t-essential graph to a second vertex that is an ancestor of the first vertex, wherein the first vertex is of a first type and the second vertex is of a second type, and wherein one of the directional relationships is from the second type to the first type; and
highlight a displayed representation of the second vertex as a possible root cause of the event related to the first computing device.

2. The system of claim 1, wherein a count of the typed DAGs is less than or equal to that of non-typed DAGs generated from the essential graph prior to edge orientation.

3. The system of claim 2, wherein the count of the typed DAGs is 1.

4. The system of claim 1, wherein the one or more processors are further configured to:
trace backward from the first vertex and through the t-essential graph to identify a third vertex that is a further ancestor of the first vertex, wherein the third vertex is of the second type; and
highlight a displayed further representation of third vertex as the possible root cause of the event.

5. The system of claim 1, wherein the one or more processors are further configured to:
trace backward from the first vertex and through the t-essential graph to identify a third vertex that is a further ancestor of the first vertex, wherein the third vertex is of a third type, and wherein one of the directional relationships is from the third type to the first type; and
highlight a displayed further representation of third vertex as the possible root cause of the event.

6. The system of claim 1, wherein the typed data represents one or more of events occurring on the plurality of computing devices, classes of the plurality of computing devices, incident reports relating to the plurality of computing devices, or knowledgebase articles relating to the plurality of computing devices.

7. The system of claim 1, wherein the typed data includes references to one or more computing devices of the plurality of computing devices, and wherein the plurality of types include indications of classes of the one or more computing devices.

8. The system of claim 1, wherein the typed data includes references to one or more events that have occurred on the plurality of computing devices, and wherein the plurality of types include indications of types of the one or more events.

9. The system of claim 1, wherein the typed data includes references to one or more incident reports relating to problems attributed to the plurality of computing devices, and wherein the plurality of types include indications of types of the one or more incident reports.

10. The system of claim 1, wherein the conditional dependency structure w is as generated from the typed data based on types of the typed data and timestamps embedded within the typed data.

11. The system of claim 1, wherein the edges of the essential graph are directed in accordance with the directional relationships comprises replacing undirected edges with directed edges.

12. The system of claim 1, wherein the second vertex has no ancestor in the t-essential graph.

13. A computer-implemented method comprising:
generating an essential graph from a conditional dependency structure for typed data relating to operation of a plurality of computing devices, wherein vertices of the essential graph represent units of the typed data, wherein the units of the typed data are of a plurality of types, and wherein edges of the essential graph respectively represent conditional dependencies between the vertices of the essential graph, wherein persistent storage contains (i) the typed data, (ii) directional relationships between pairs of the plurality of types, and (iii) the conditional dependency structure;
orienting the edges of the essential graph such that they are directed in accordance with the directional relationships;
generating typed directed acyclic graphs (DAGs) based on the essential graph, wherein vertices of the typed DAGs are of the plurality of types, and wherein edges of the typed DAGs are in accordance with the directional relationships;
forming a t-essential graph from a union of the typed DAGs;
identifying an event related to a first computing device of the plurality of computing devices, wherein the event or the first computing device is represented as a first vertex in the t-essential graph, and wherein the first vertex is of a first type;
tracing backward from the first vertex and through the t-essential graph to identify a second vertex that is an ancestor of the first vertex, wherein the second vertex is of a second type, and wherein one of the directional relationships is from the second type to the first type; and
providing a representation of the second vertex as a possible root cause of the event.

14. The computer-implemented method of claim 13, wherein a count of the typed DAGs is less than or equal to that of non-typed DAGs generated from the essential graph prior to edge orientation.

15. The computer-implemented method of claim 13, further comprising:
tracing backward from the first vertex and through the t-essential graph to identify a third vertex that is a further ancestor of the first vertex, wherein the third vertex is of the second type; and
providing a further representation of third vertex as the possible root cause of the event.

16. The computer-implemented method of claim 13, wherein the typed data includes references to one or more computing devices of the plurality of computing devices, and wherein the plurality of types include indications of classes of the one or more computing devices.

17. The computer-implemented method of claim 13, wherein the typed data includes references to one or more events that have occurred on the plurality of computing devices, and wherein the plurality of types include indications of types of the one or more events.

18. The computer-implemented method of claim 13, wherein the typed data includes references to one or more incident reports relating to problems attributed to the plurality of computing devices, and wherein the plurality of types include indications of types of the one or more incident reports.

19. The computer-implemented method of claim 13, wherein the conditional dependency structure is generated from the typed data based on types of the typed data and timestamps embedded within the typed data.

20. An article of manufacture including a non-transitory computer-readable medium, having stored thereon program instructions that, upon execution by a computing system, cause the computing system to perform operations comprising:
generating an essential graph from a conditional dependency structure for typed data relating to operation of a plurality of computing devices, wherein vertices of the essential graph represent units of the typed data, wherein the units of the typed data are of a plurality of types, and wherein edges of the essential graph respectively represent conditional dependencies between the vertices of the essential graph, wherein persistent storage contains (i) the typed data, (ii) directional relationships between pairs of the plurality of types, and (iii) the conditional dependency structure;
orienting the edges of the essential graph such that they are directed in accordance with the directional relationships;
generating typed directed acyclic graphs (DAGs) based on in the essential graph, wherein vertices of the typed DAGs are of the plurality of types, and wherein edges of the typed DAGs are in accordance with the directional relationships;
forming a t-essential graph from a union of the typed DAGs;
identifying an event related to a first computing device of the plurality of computing devices, wherein the event or the first computing device is represented as a first vertex in the t-essential graph, and wherein the first vertex is of a first type;
tracing backward from the first vertex and through the t-essential graph to identify a second vertex that is an ancestor of the first vertex, wherein the second vertex is of a second type, and wherein one of the directional relationships is from the second type to the first type; and
providing a representation of the second vertex as a possible root cause of the event.
